(19) United States
(12) Patent Application Publication
(10) Pub. No.: US 2026/0077473 A1
(43) Pub. Date: Mar. 19, 2026

(54) WORK SURFACE

(71) Applicant: Dash-Board Portable Workshop, LLC, Boulder, CO (US)

(72) Inventor: Robert A. Schumacher, Boulder, CO (US)

(73) Assignee: Dash-Board Portable Workshop, LLC, Boulder, CO (US)

(21) Appl. No.: 19/326,269

(22) Filed: Sep. 11, 2025

Related U.S. Application Data
(60) Provisional application No. 63/696,750, filed on Sep. 19, 2024.

(51) Int. Cl. B25H 1/08; B25H 1/02

(52) U.S. Cl. CPC B25H 1/08; B25H 1/02

(57) ABSTRACT

A work surface is provided. More particularly, a work surface that is portable, and that when deployed provides a relatively stable platform is disclosed. The work surface includes at least two horizontal clamp tracks running parallel to a top surface, and can further include one or more vertical clamp tracks running parallel to the legs of the work surface. The top surface can include first and second surface components that are separated from one another by a replaceable cut strip. The first and second surface components and the cut strip can lie in a common top surface plane. The horizontal clamp tracks are configured to receive various accessories, such as a guide rail and an extension surface. In addition, various alignment tools that are configured for use with the work surface and work surface accessories are provided.

### CROSS-REFERENCE TO RELATED APPLICATIONS

This application claims the benefit of U.S. Provisional Patent Application Ser. No. 63/696,750, filed Sep. 19, 2024, the entire disclosure of which is hereby incorporated herein by reference.

### FIELD

A work surface with enhanced flexibility and features, and related accessories, is provided.

### BACKGROUND

The traveling carpenter, cabinetmaker/installer, and general handyperson has always needed easily transportable work surfaces for jobsite use. Traditional devices invariably involve multiple compromises between mobility, complexity, weight, versatility, and ergonomics. The skilled craftsperson requires a strong, flat, rigid, stable platform that can be set up easily, quickly, and accurately in various environments, and which allows comfortable access to workpieces of many sizes. Typical solutions to these needs involve saw horses with plywood or old doors placed on top to make a platform.

These are unstable and irregular and are poor substitutes for the sort of stout workbench that would traditionally be used in a workshop, but which is too heavy and cumbersome to transport.

Numerous attempts have been made during the last 100 years to devise a good, mobile substitute for the shop bench. To varying extents, all are defined by compromise, whether in pursuit of light weight, convenient size based on transportability, and/or the complexity/variety of integrated features and accessories. Common complaints are that, for example, what is available is too small to be of practical use, too low, too flexible, or too constrained by an ill-conceived method of work to allow the craftsperson to fully utilize his/her creativity in an efficient way. Previous attempts at providing a portable workbench have also resulted in designs that are limited in their ability to provide support for materials of different sizes, and that are not long lasting.

In addition, it is useful to integrate various accessories with a work surface. For example, guides and mounts to facilitate making cuts, such as crosscuts, using power saws have been developed. However, existing assemblies have been unable to provide the levels of precision required for high quality wood working. Also, the guides and mounts associated with previous assemblies have not been able to accommodate a very wide range of material sizes. As another example, it can be desirable to use a work surface in combination with a portable table saw. However, universal supports capable of providing a secure and accurately aligned connection between such table saws, work surfaces, and guides and mounts associated with such work surfaces have not been available.

### SUMMARY

Embodiments of the present disclosure provide a system that includes a work surface or workbench assembly for supporting workpieces. More particularly, a portable work surface or workbench and associated accessories that are stable, that enable precise cuts or other procedures to be performed, and that can be configured to hold workpieces of various sizes, including workpieces that are large relative to the work surface, are provided.

In accordance with the least to some embodiments of the present disclosure, the work surface includes a planar top surface, and a plurality of legs that are folded against a back of the planar top surface when the workbench is in a folded configuration, and that extend such that they are substantially orthogonal to the planar top surface when the work surface is in a deployed configuration. The perimeter of the work surface can be surrounded by horizontal rails that support the top surface, and that are configured to receive various components and accessories. The legs can be joined to the rails. For instance, the legs can be pivotally joined to opposing longitudinal rails disposed along front and back edges of the work surface.

The top surface can include first and second surface components, separated by a cut strip. In accordance with embodiments of the present disclosure, the first and second surface components are separate pieces having a first thickness, with the cut strip also having the first thickness and with the cut strip disposed between the first and second work surface components. A joining plate that extends from under a portion of the first work surface component, under the cut strip, and under a portion of the second work surface component, is disposed on the back of the planar top surface. The joining plate can include a number of clearance features, allowing unimpeded use of holes or apertures provided in the first and second work surface components for receiving tools, clamps, dogs, locating devices, or accessories. Fastening holes in the joining plate receive fasteners, which interconnect the joining plate to the first and second work surface components. The cut strip can be provided as an element that is placed in a space between the first and second work surface components and on a top surface of the joining plate. Replacement of a worn cut strip can be performed by lifting the cut strip to be replaced from between the first and second work surface components, away from the joining plate, and then dropping a replacement cut strip into the space vacated by the worn cut strip.

In accordance with further embodiments of the present disclosure, accessories that can be interconnected to the work surface include brackets, pivot plates, or other components that can be connected to rails, either directly or via base plates. The components and base plates are configured to provide a support surface that is aligned with a surface of the rail to which the component, baseplate, or both the component and bases plate are connected. The rails to which such components or baseplates can be connected include horizontal rails disposed around the perimeter of the work surface, and vertical rails disposed along the legs.

The components that are connected to the rails can include accessories, such as guide rails. In accordance with at least some embodiments of the present disclosure, a guide rail can be mounted to the horizontal rail extending along the back edge of the work surface by a pivot plate assembly. The guide rail includes a guide member having a length that allows the guide rail to extend from the pivot plate assembly to a point past a mounting bracket assembly that is mounted to a horizontal rail extending along the front edge of the work surface. As a result, the guide rail can be lifted away from or placed against the top of the work surface by pivoting the guide member around a pivot axis defined by the pivot plate assembly. When the guide rail is placed against the top of the work surface, a downwardly extending locating rod disposed on a bottom side of the guide member can be received in an open ended receiving slot provided as part of the bracket mounted to the horizontal rail extending along the front edge of the work surface. In use, the guide rail can be pivoted away from the work surface, and a work piece can then be placed between the work surface and the guide rail. The guide rail can then be placed against the work piece by pivoting the guide rail in the opposite direction. The thickness of the work piece can be accommodated by adjusting a height of the pivot axis at the pivot plate assembly, and by the length of the locating rod.

Embodiments of the present disclosure can further include an extension surface. The extension surface can include a mounting plate along a first edge and one or more legs at or adjacent a second edge that is opposite the first edge of the extension surface.

The mounting plate can include mounting points that are configured to connect the extension surface to a horizontal rail of the work surface. In accordance with further embodiments of the present disclosure, the mounting plate can also include provisions for adjusting the location of at least some of the mounting points, enabling the extension surface to the connected to work surfaces having a number of different configurations. In accordance with still further embodiments, the extension surface can include horizontal rails along some or all of the edges of a top surface of the extension surface. The extension surface can also include vertical rails extending along the legs of the extension surface. The vertical rails can lie in a same plane as a horizontal rail disposed along an edge of the top of the extension surface from which legs extend.

In accordance with still further embodiments of the present disclosure, accessories configured for use with the work surface can include various gauges, blocks or components for holding a workpiece in a desired location on the work surface, and tools for ensuring a selected alignment of a workpiece, either directly or through an associated alignment device, such as a fence or guide. Accessories can also include alignment tools and replacement plates for accommodating different tools, such as saw blades having different kerfs.

Additional features and advantages of embodiments of the present disclosure will become more readily apparent from the following description, particularly when taken together with the accompanying drawings.

### BRIEF DESCRIPTION OF THE DRAWINGS

FIG. 1 is a top perspective view of a workbench in accordance with embodiments of the present disclosure, in a deployed configuration;

FIG. 2 is a top plan view of the workbench of FIG. 1;

FIG. 3 is a side elevation of the workbench of FIG. 1, in a folded configuration;

FIG. 4 is a bottom plan view of the workbench of FIG. 1, in a folded configuration;

FIG. 5 is a side elevation of the workbench of FIG. 1, in a deployed configuration;

FIG. 6 is an end elevation of the workbench of FIG. 1, in a deployed configuration;

FIG. 7 is a side elevation of the workbench of FIG. 1, in a deployed configuration, and with vertical clamp tracks installed;

FIG. 8 is an end elevation of the workbench of FIG. 1, in a deployed configuration, and with vertical clamp tracks installed;

FIG. 9 is a perspective view of a vertical clamp track and an installed support block in accordance with embodiments of the present disclosure;

FIG. 10 is a front perspective view of a support block in accordance with embodiments of the present disclosure;

FIG. 11 is a rear perspective view of a support block in accordance with embodiments of the present disclosure;

FIG. 12 is a side elevation view of the workbench of FIG. 1, with vertical clamp tracks installed, and with a relatively large work piece held against a side of the workbench;

FIG. 13 is an end elevation view of the workbench of FIG. 1, with vertical clamp tracks installed, and with a relatively large work piece held against a side of the workbench;

FIG. 14 is a side elevation view of the workbench of FIG. 1, with vertical clamp tracks installed, and with a relatively small work piece held against a side of the workbench;

FIG. 15 is a side elevation view of the workbench of FIG. 1, with vertical clamp tracks installed, and with a relatively small work piece held against a side of the workbench and using an alternate support block arrangement;

FIG. 16A is a top perspective view of a workbench with attached cross cut accessories in accordance with embodiments of the present disclosure;

FIG. 16B is a top perspective view of the workbench with attached cross cut accessories of FIG. 16A, and with a saw guide, saw, and work piece;

FIG. 16C is another top perspective view of the workbench with attached cross cut accessories of FIG. 16A;

FIGS. 17A-C are views of a saw guide pivot assembly in accordance with embodiments of the present disclosure;

FIGS. 18A-B are exploded views of a pivot plate and a T-bar in accordance with embodiments of the present disclosure;

FIG. 18C is a detail view of an interface between an attachment assembly and a saw guide;

FIGS. 19A-D are views of a saw guide support in accordance with embodiments of the present disclosure;

FIGS. 20A-C are views of a workbench in accordance with other embodiments of the present disclosure;

FIGS. 21A-Q are views of a workbench and an attached cross cut accessory in accordance with other embodiments of the present disclosure;

FIGS. 22A-F are views of a workbench extension surface in accordance with embodiments of the present disclosure;

FIG. 23 is a detail of an interconnection between a workbench extension surface and a workbench in accordance with embodiments of the present disclosure; and

FIGS. 24A-N are views of a rip gauge in accordance with embodiments of the present disclosure.

### DETAILED DESCRIPTION

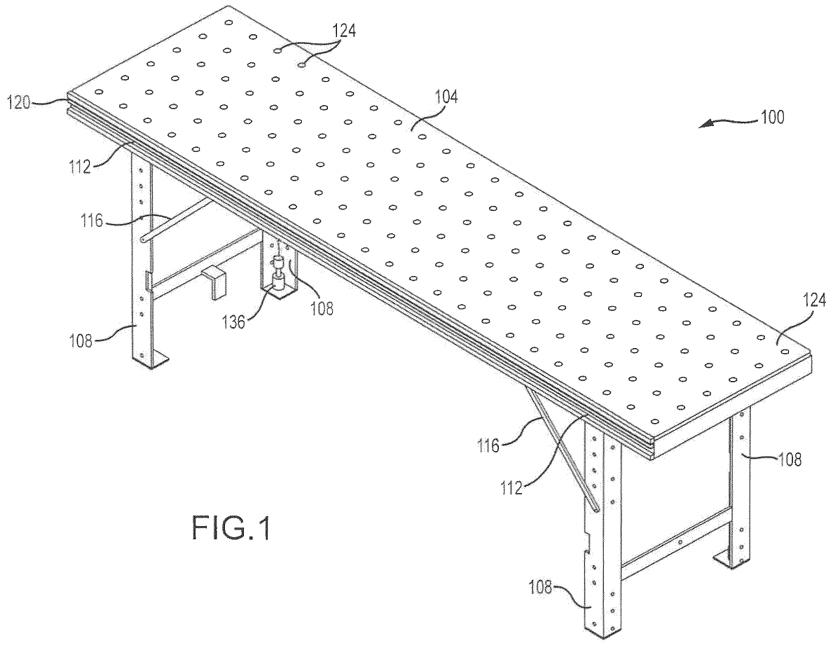

With reference now to FIG. 1, embodiments of the present disclosure provide a work surface or workbench 100. In accordance with at least some embodiments, the workbench 100 includes a portable work surface that can be configured in a relatively compact state for portability, and a stable, extended state for use. The workbench 100 generally includes a top surface 104, and a plurality of legs 108 that are connected to the top surface 104 by hinges or pivots 112. When configured for portability, the legs 108 are folded or stowed, such that the longitudinal axis of each leg is generally parallel to a plane corresponding to a top of the top surface 104. In a deployed state, the legs 108 are generally orthogonal to the plane of the top surface 104. The legs 108 can be held in the deployed position by braces 116. The braces 116 can be connected to the top surface 104 via a track that allows the braces to be moved with the legs, such that the braces 116 are generally parallel to the top surface 104 and the legs 108 when the legs are stowed, and such that the braces are at an angle (e.g. a 45° angle) to the top surface 104 and the legs 108 when the legs 108 are extended. In the extended position, the location of the braces 116 within the horizontal clamp track can be fixed, for example by a threaded fastener.

The workbench or table 100 is generally brought to a worksite in a folded configuration, with the legs 108 locked against a bottom of the top surface 104 by brackets and associated threaded fasteners. In order to deploy the workbench 100 for use, the threaded fasteners holding the brackets are removed, and the legs 108 are extended such that the longitudinal axes of the legs 108 are generally orthogonal to a plane of the top surface 104. As the legs 108 are pivoted on the hinges 112, the ends of the braces 116 attached to the top surface 104 at the rails slide along those rails. Once the legs 108 are fully extended, which can correspond to the braces 116 reaching an end of the horizontal rails, fasteners attaching the ends of the braces 116 to the top surface 104 can be tightened, to fix the position of the legs 108 relative to the top surface 104. After the legs 108 have been deployed, leg leveler assemblies 136 can be adjusted by turning the support leg in the threaded insert, to prevent rocking of the workbench 100 while it is in use.

A horizontal rail or clamp track 120 can be provided along one or more edges of the top surface 104. More particularly, and as discussed in greater detail elsewhere herein, the horizontal clamp track 120 is oriented such that workpieces can be clamped against a side of the top surface 104. Accordingly, for example where a workpiece is substantially planar, the workpiece is at an angle of 90° with respect to the plane of the top surface 104 when the workpiece is held by a clamp placed in the horizontal clamp track 120. In addition, the planar top surface 104 can feature a plurality of holes 124 that are configured to receive clamps, dogs, and/or other accessories. The holes 124 can be arranged in a two-dimensional grid or array pattern across the top surface 104.

A leg leveler assembly 136 can be provided at a bottom end of each leg 108. Each leg leveler assembly 136 can include a threaded insert that is fixed to the associated leg 108. As an example, but without limitation, the threaded insert can include a captured nut that is friction fit and/or adhered to a support block that is in turn fixed to the leg 108.

The amount by which a support surface of the leg leveler assembly 136 extends beyond the bottom of the leg 108 can be adjusted by, for example, placing a wrench or other tool on the head portion, and turning the threaded insert.

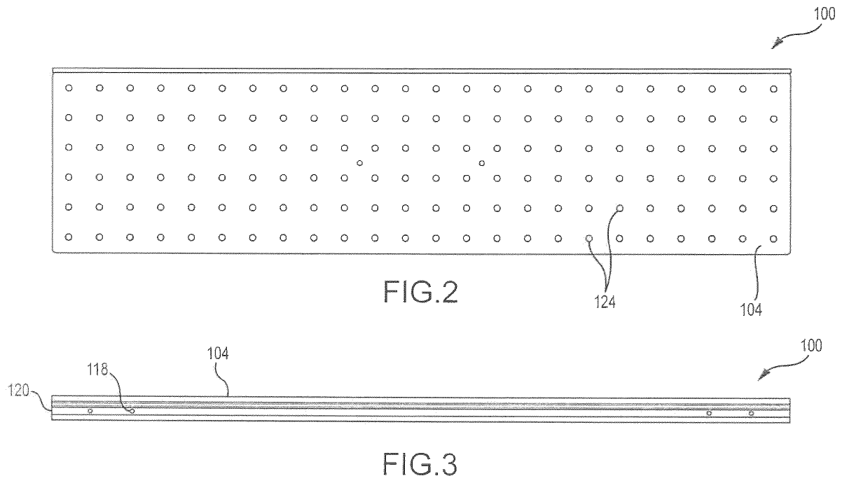

FIG. 2 depicts the workbench 100, and in particular the top surface 104, in plan view. As shown, the holes or apertures 124 can be configured to form a grid of holes 124 that are regularly spaced across the top surface 104. As can be appreciated by one of skill in the art after consideration of the present disclosure, the holes 124 can receive various tools, clamps, and locating devices or accessories.

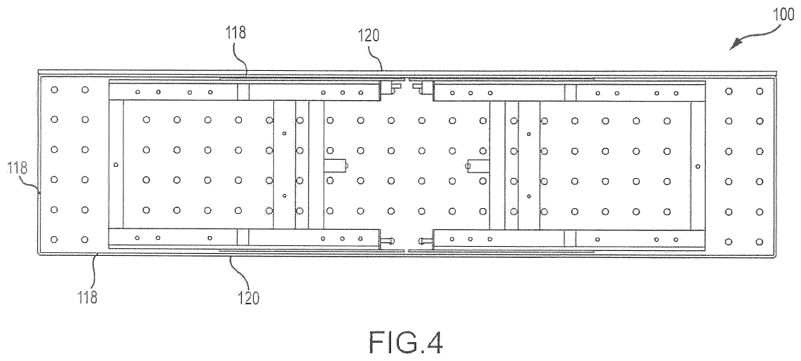

FIG. 3 depicts the workbench 100 in elevation, and FIG. 4 depicts the work surface 100 in a bottom plan view, with the legs 108 folded parallel to the top surface 104, in a portable configuration. In this configuration, the legs 108 can be nested within sidewalls 118, for example formed by or associated with horizontal clamp tracks 120 located around a perimeter of the top surface 104.

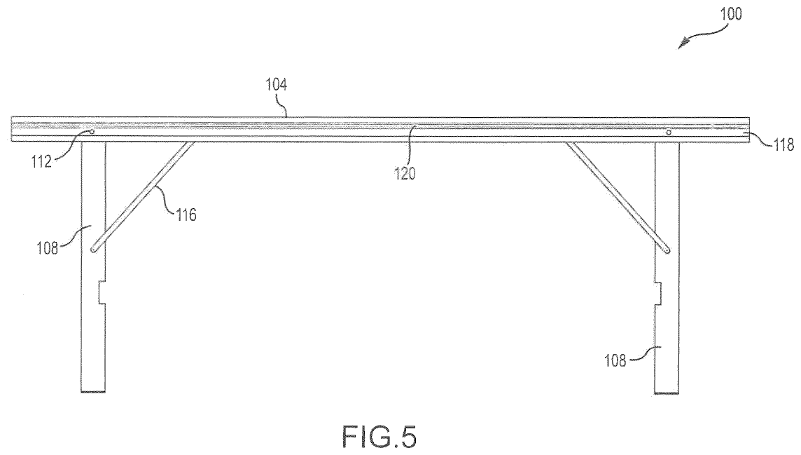

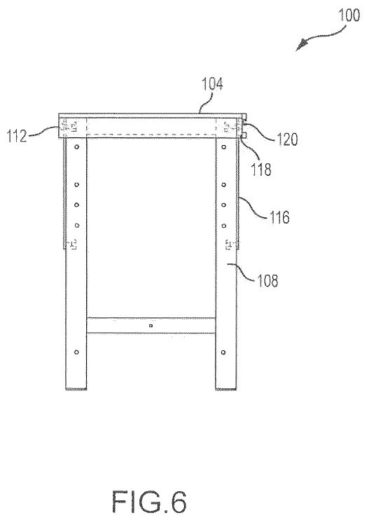

FIG. 5 depicts the workbench100 in a side elevation, and FIG. 6 depicts the workbench 100 in an end elevation, in a deployed or standing configuration.

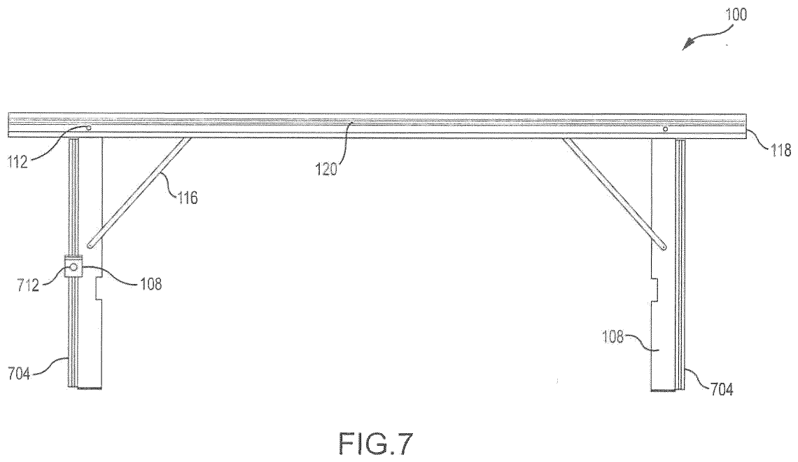

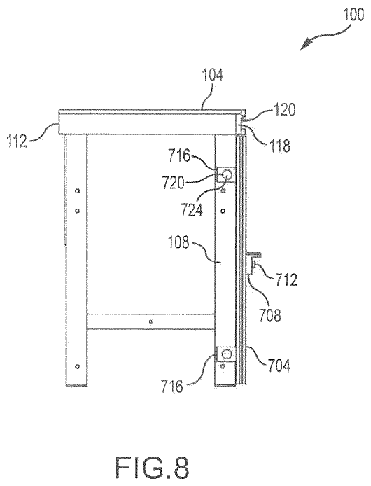

FIG. 7 depicts the workbench 100 in a side elevation, and FIG. 8 depicts the work surface 100 in an end elevation, in a deployed or standing configuration, and with vertical rails or clamp tracks 704 installed. More particularly, the vertical clamp tracks 704 are shown attached to first 108a and second 108b legs of the workbench 100. A support block 708 can be received by the vertical clamp track 704. The position of the support block 708 along the vertical clamp track 704 can be adjusted. More particularly, a fastening knob 712 associated with a threaded fastener can be loosened to move the support block 708 along the vertical clamp track 704, and can be tightened to secure the support block 708 at a desired location.

With particular reference now to FIG. 8, the vertical clamp tracks 704 can include mounting flanges or members 716. The vertical clamp tracks 704 can be attached to an associated leg 108 by threaded fasteners 720 that pass through the mounting-flange 716 and that are associated with a knob 724. As an example the position of the vertical clamp tracks 704 on the respective legs 108 can be determined by the threaded fasteners 720 and captured nuts on the legs 108 that receive the threaded fasteners 720, in combination with locating surfaces. In accordance with embodiments of the present disclosure, an outer surface of the vertical clamp tracks 704 is coincident with a plane that also is coincident with an outer surface of the horizontal clamp track 120. Although depicted in FIG. 7 as having the vertical clamp tracks 704 on both legs 108 on a side of the workbench 100, other configurations are possible. For example, a vertical clamp track 704 can be associated with a single leg 108, all of the legs 108, or some other number of legs 108, of the workbench 100.

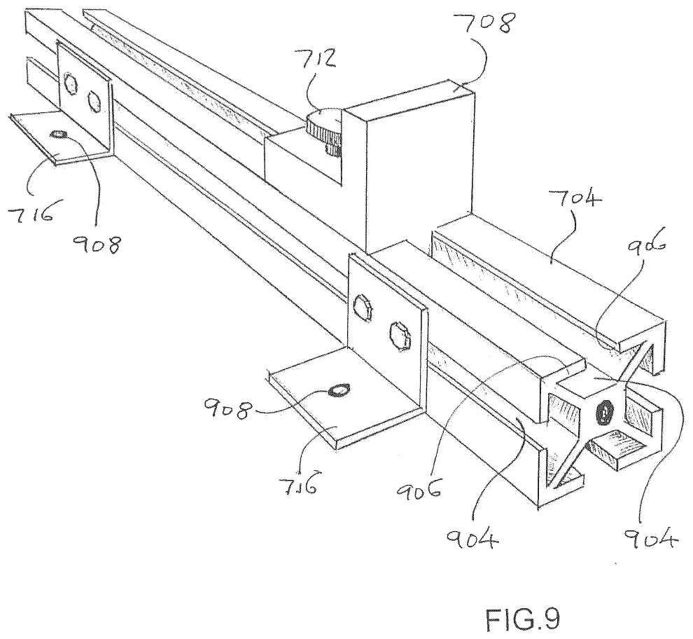

With reference now to FIG. 9, a vertical clamp track 704 is shown in a perspective view. In this example, the vertical clamp track 704 has channels 904 and associated flanges 906 formed on each of four sides of the vertical clamp track 704, when the vertical clamp track 704 is viewed in cross-section. The mounting flanges 716 can include holes 908 for receiving the threaded fasteners 720, for instance as illustrated in FIG. 8. The mounting flanges 716 can be permanently or removably fixed to the vertical clamp track 704, for example using fasteners received within one of the channels 904.

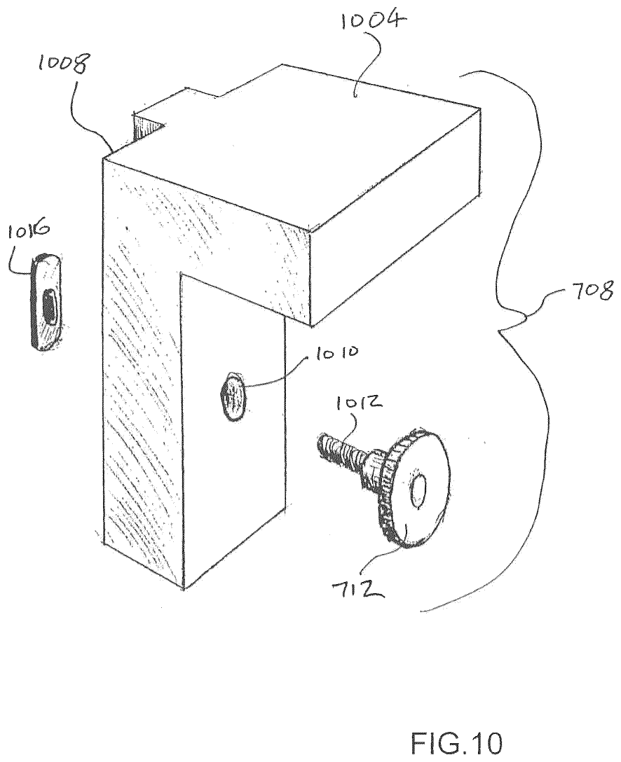

With reference now to FIG. 10, a support block 708 is shown in a top perspective view. In particular, the support block 708 includes a planar top or support surface 1004 that is perpendicular to a back surface 1008. Accordingly, when the support block 708 is received by a vertical clamp track 704, the back surface 1008 is parallel to a longitudinal axis of the vertical clamp track 704, while the support surface 1004 is perpendicular to the longitudinal axis of the vertical clamp track 704. In addition, the fastening knob 712, receiving hole 1010, threaded fastener 1012 connected to the knob 712, and threaded plate 1016 that receives the threaded fastener 1012 to secure the support block 708 at a desired location along a vertical clamp track 704 are shown.

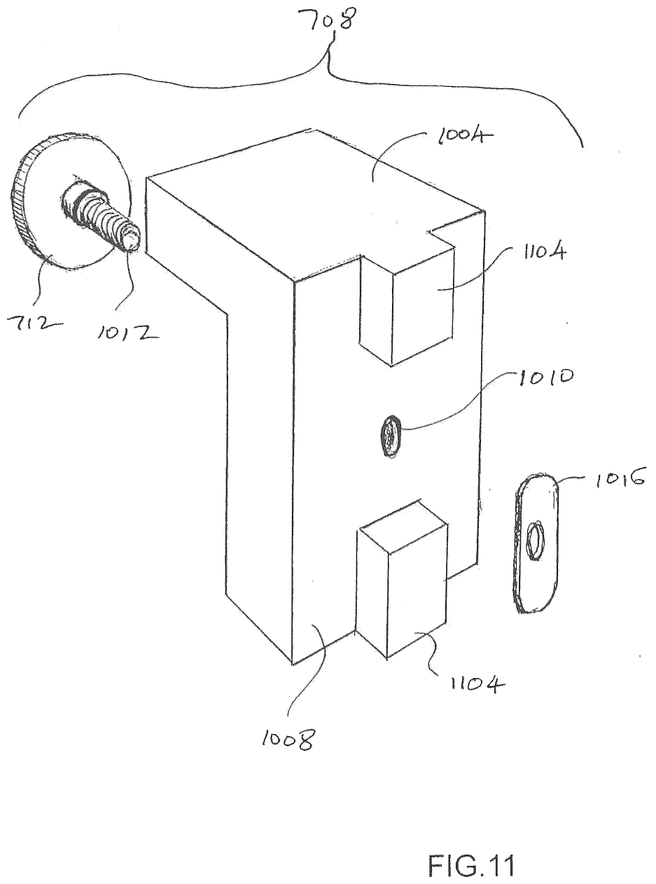

With reference now to FIG. 11, an exploded, rear perspective view of a support block 708 is shown. In this view, it can be seen that the threaded plate 1016 may have a width that is slightly larger than a gap between the flanges 906 of a channel 904 of the vertical clamp track 704. Accordingly, when installed through an end of the vertical clamp track 704, the support block 708 is captured within the receiving channel 904. As shown, the support block 708 can also include one or more locating members 1104. For example, as shown in FIG. 11, locating members 1104 can be provided on either side of the threaded plate 1016, to maintain an alignment of the support block 708 relative to the vertical clamp track 704. In particular, the support surface 1004 of the support block 708 can be maintained in an orientation that is about (e.g., within ±3°) of being co-planar with the top surface 104 of the workbench 100. In accordance with at least some embodiments of the present disclosure, the locating members 1104 can have a t-shaped profile, to capture the support block 708 within the receiving channel 904.

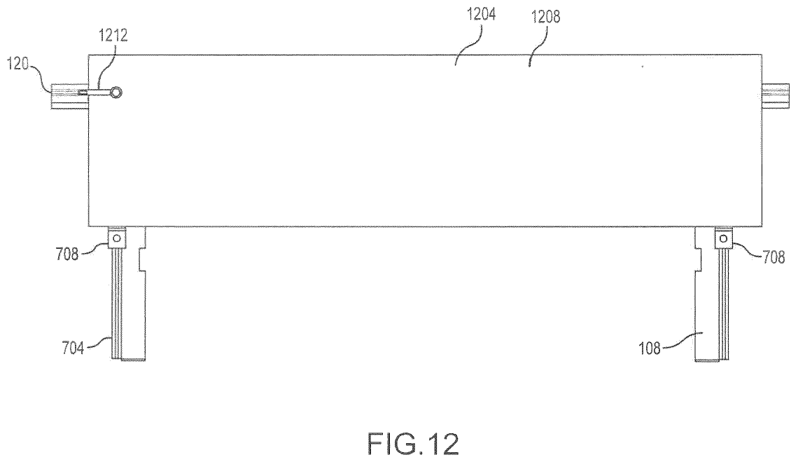

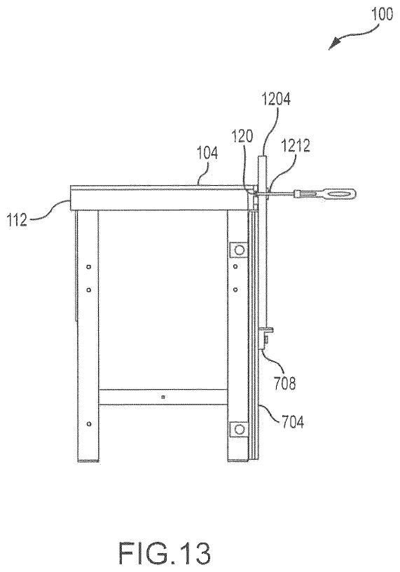

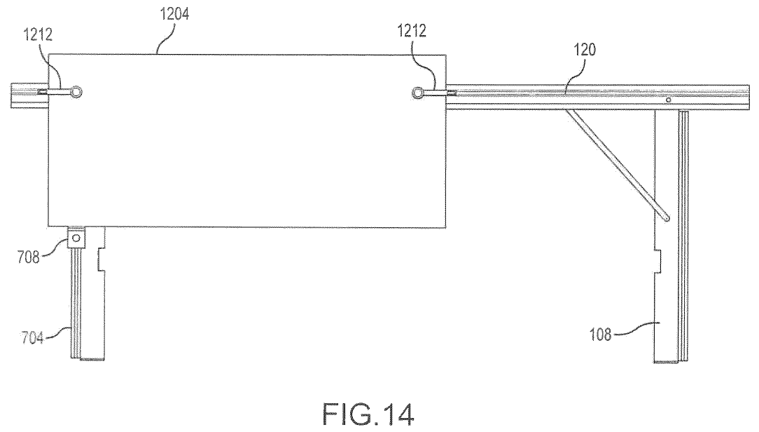

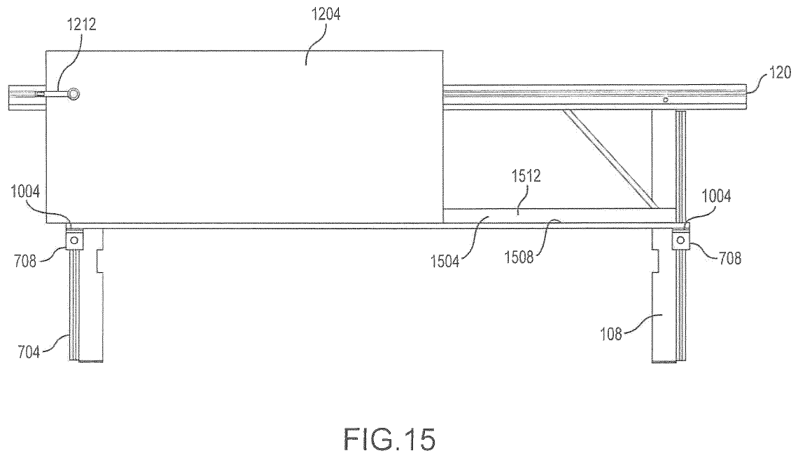

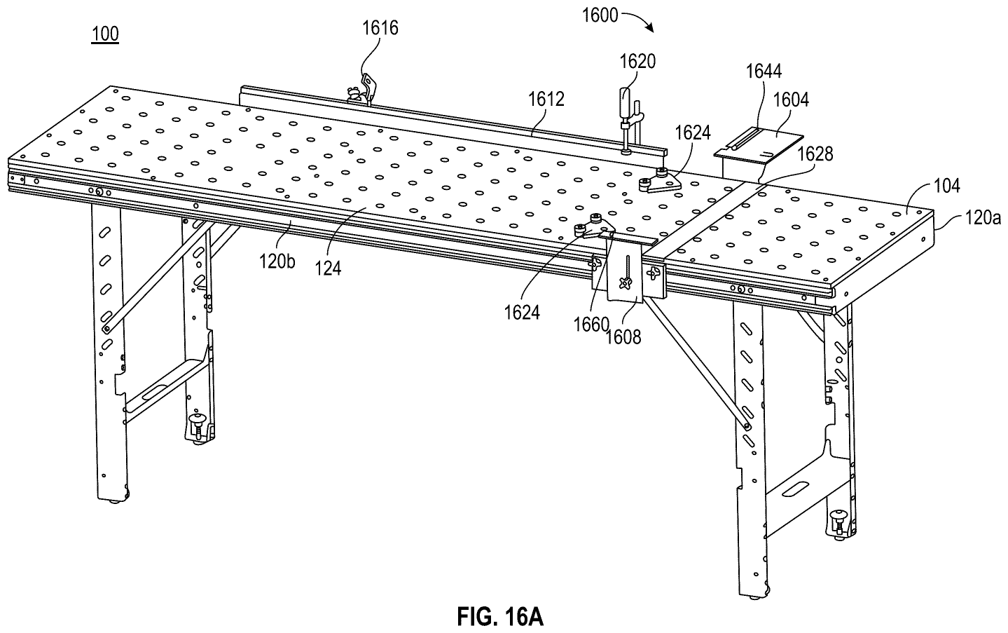

In addition to supporting workpieces, tools, or other objects on the top surface 104, the table 100 can be configured to hold workpieces during various machining operations. For example, as shown in FIGS. 12-15, components of the table 100 can be configured so as to provide a door/panel support. A door/panel support can be implemented by placing one or more support blocks 708 in vertical clamp tracks 704 attached to one or more legs 108. A planar work piece 1204, such as a door or panel 1208, can then be supported along one edge by the one or more support blocks 708. In addition, the door or panel 1208 can be held against an edge of the top surface 104 by a clamp 1212 placed in the horizontal clamp track 120. Where the work piece 1204 is too short to extend between support blocks 708 on adjacent legs 108, for example as shown in FIG. 14, that work piece 1204 can be placed on one support block 708 at a first end, and can be held by friction against an edge of the top surface 104 by one or more clamps 1212 placed in the horizontal clamp track 120. As yet another alternative, as illustrated in FIG. 15, a pair of support blocks 708 can support or be connected to a support member 1504 that extends between opposed support blocks 708. The support member 1504 can include a first support surface 1508 that is co-planar with the support surfaces 1004 of the support blocks 708. In addition, the support member 1504 can include a back surface 1512 that is co-planar with an outer surface of the vertical clamp tracks 704 and of the horizontal clamp track 120. As shown, the work piece 1204 can further be secured by a clamp 1212 placed in the horizontal clamp track 120. Accordingly, even workpieces 1204 of relatively small size can be held against the side of the support surface 100.

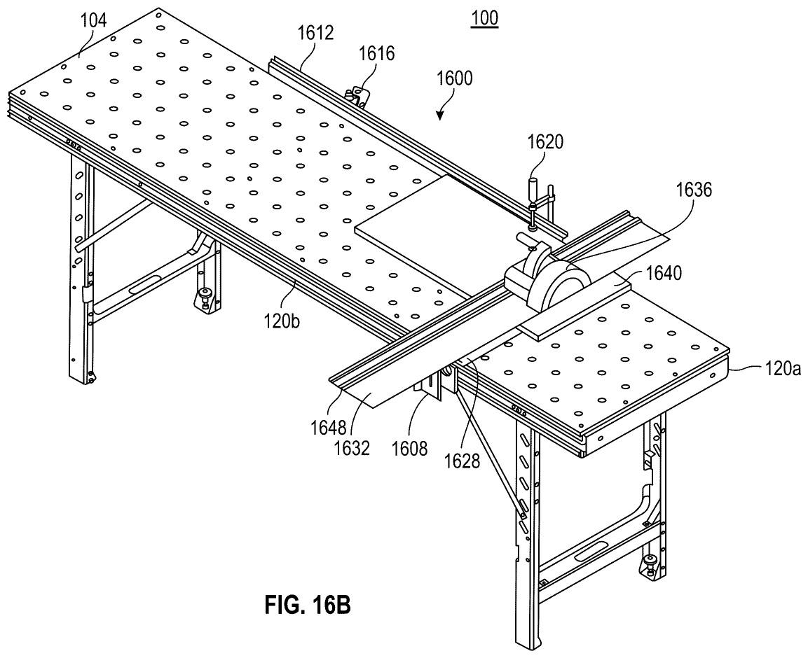

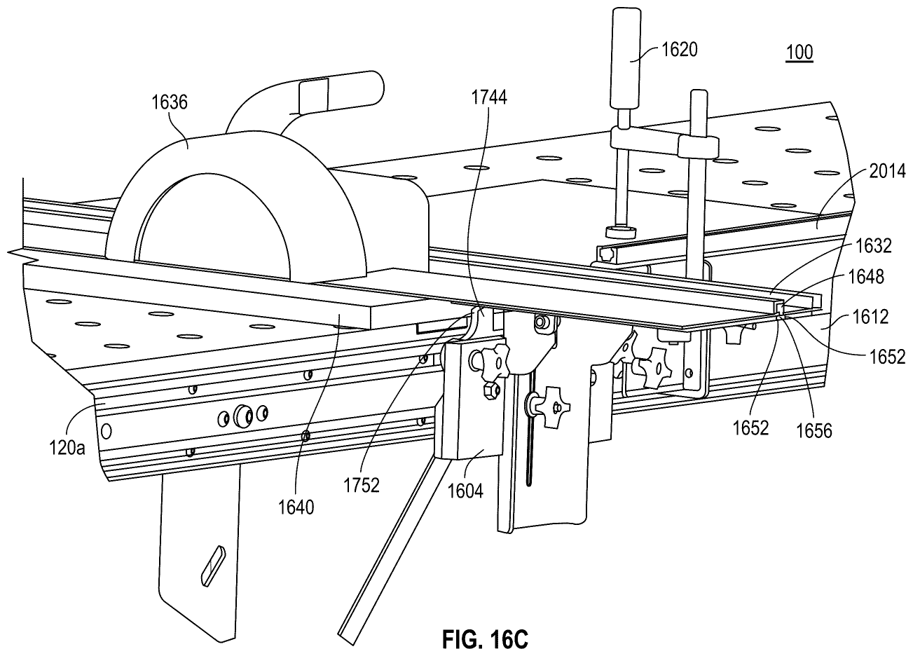

With reference now to FIG. 16A, a workbench 100, with cross cut accessories 1600 installed, is depicted. The cross cut accessories 1600 can include a saw guide pivot plate assembly 1604, a saw guide support 1608, one or more fences 1612, a flip stop 1616, a work holding clamp 1620, and one or more set up arrows 1624. In addition, a workbench 100 can be provided with a cross cut groove or recess 1628, to provide clearance for the blade of a saw used during cross cut operations. The saw guide pivot assembly 1604 and the fences 1612 are attached to the horizontal clamp track 120a located along the rear edge of the top surface 104. The lateral position of the saw guide pivot assembly 1604 and the fences 1612 can be adjusted by moving those components 1604 and 1612 along the horizontal clamp track 120a, and the selected lateral position can then be fixed using friction knobs or clamps. The saw guide support 1608 is attached to the horizontal clamp track 120b located along the front edge of the top surface 104.

The lateral position of the saw guide support 1608 can be adjusted by moving the support 1608 along the horizontal clamp track 120b, and fixed using a friction knob or clamp.

The set up arrows 1624 can be used, for example in combination with a saw guide, to ensure that the saw guide pivot assembly 1604 and the saw guide support 1608 are properly aligned. In accordance with embodiments of the present disclosure, the set up arrows can include pegs that are received by the holes 124 in the top surface 104 of the table 100. The set up arrows 1624 can be removed during sawing operations.

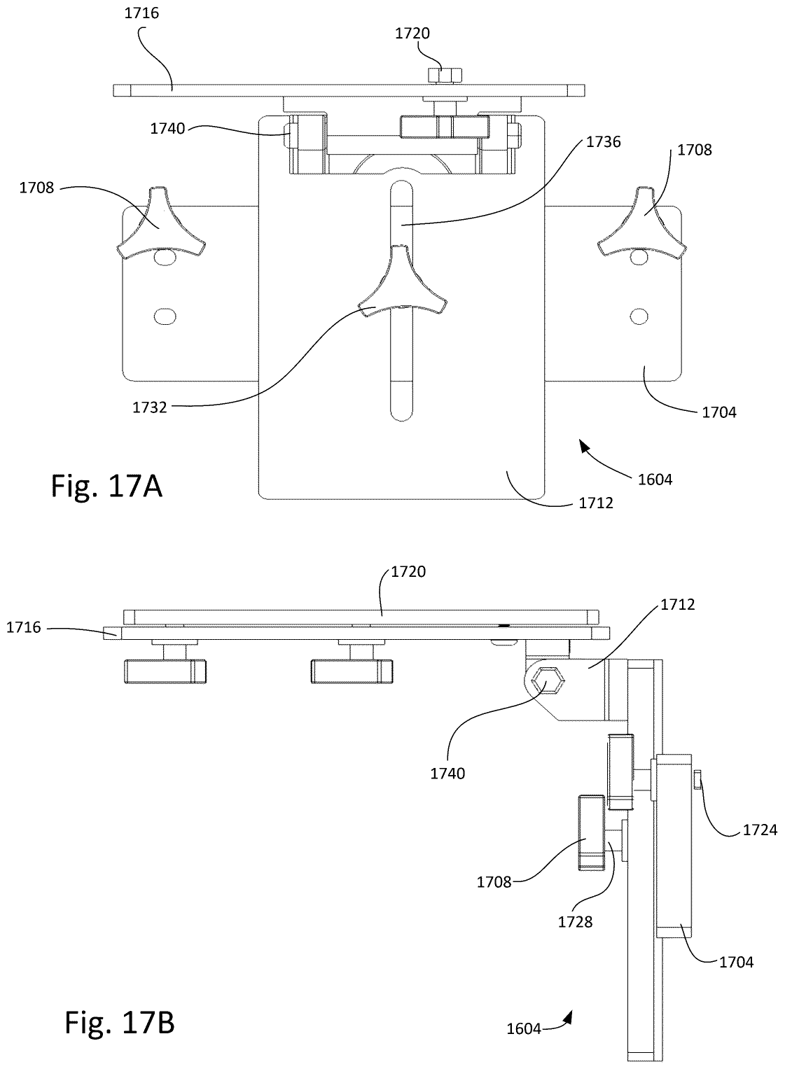

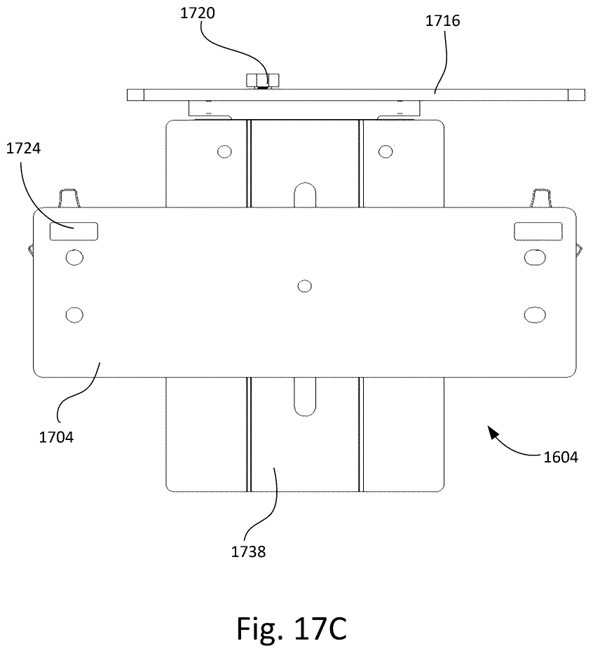

In FIGS. 16B and 16C, the workbench 100 and cross cut accessories 1600 are shown with a saw guide 1632 and a saw 1636 installed thereon, and with a work piece 1640 in position to be cut. The saw guide 1632 can include a groove 1648 having a pair of opposed, co-planar flanges 1652 with a space 1656 therebetween. The saw guide 1632 is attached at one end to the pivot plate assembly 1604 by a T-bar 1644 that is received in the groove 1648 of the saw guide 1632, behind the flanges 1652, such that the T-bar, when tightened, clamps a portion of the flanges 1652 between the T-bar 1644 and a surface of the pivot plate assembly 1604 (see FIGS. 16A, 16C, 17A-C, and 18A-B). The saw guide 1632 rests on the saw guide support 1608, with a locating pin 1660 of the saw guide support 1608 received in the space 1656 between the flanges 1652 of the groove 1648 to stabilize the saw guide 1632 laterally.

With reference now to FIGS. 17A-C, the pivot plate assembly 1604 is shown in rear elevation, left side elevation, and front elevation views respectively. The pivot plate assembly 1604 generally includes a base plate 1704, which includes mounts 1708 for attaching the pivot plate assembly 1604 to a track 120, a riser 1712, a pivot plate 1716, and an attachment assembly 1720. The mounts 1708 can include a threaded plate 1724 and a threaded fastener 1728. The threaded plate 1724 is received by the horizontal clamp track 120 when the pivot plate assembly 1604 is attached to the table 100. The location of the pivot plate assembly 1604 along the track 120 can be fixed by tightening the mount 1708, and the pivot plate location can be adjusted by loosening the mount 1708 and moving the pivot plate assembly 1604 to a desired position along the track 120. The height of the pivot plate 1716 can be adjusted by loosening a threaded fastener 1732 that extends through a vertical adjustment slot 1736 in the riser 1712, moving the riser 1712 within a channel formed in the base plate 1704 until the pivot plate 1716 is at a desired height, and tightening the threaded fastener 1732 to secure the riser 1712 and the pivot plate 1716 relative to the base plate 1704. The pivot plate 1716 includes a hinge 1740 that allows the pivot plate 1716 to pivot relative to the remainder of the pivot plate assembly 1604, which allows an attached saw guide 1632 to be lifted out of engagement with the saw guide support 1608 and away from the top surface 104 of the table 100, for example to facilitate placing a workpiece under the saw guide 1632.

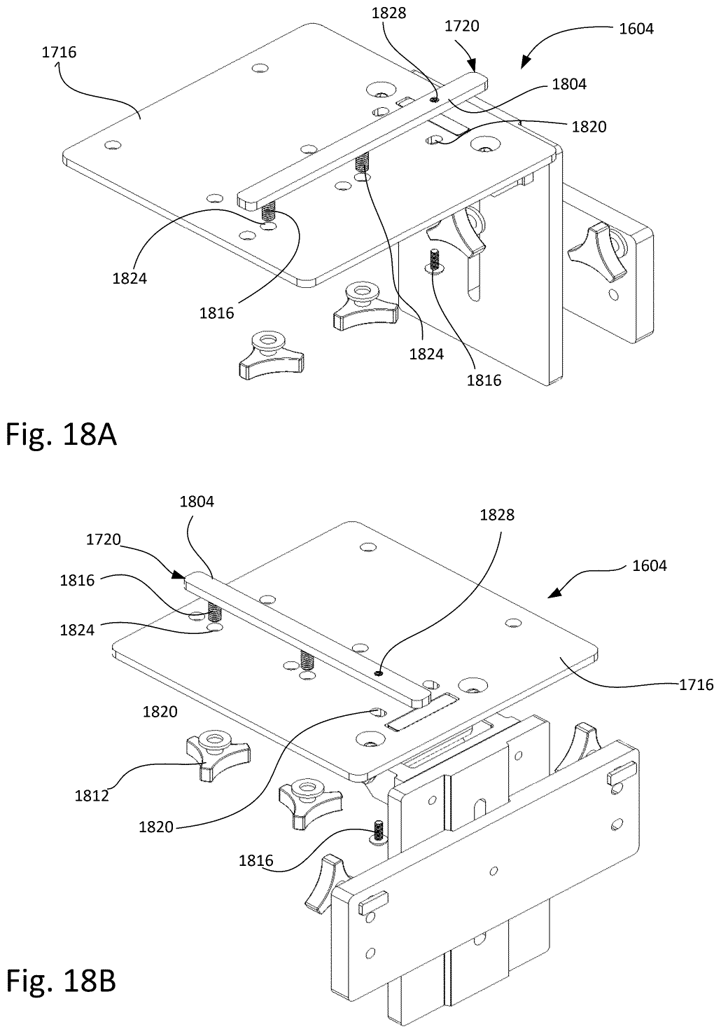

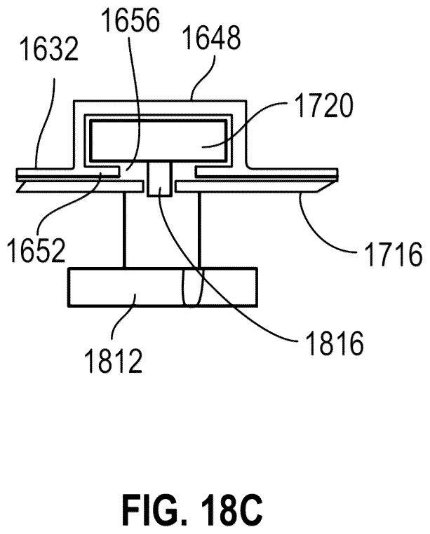

FIGS. 18A-B are front top perspective and rear top perspective views respectively of a pivot plate assembly 1604, showing details of the attachment assembly 1720 in accordance with embodiments of the present disclosure. In particular, the attachment assembly 1720 can include a T-bar 1804 that is dimensioned such that it can be received within a track of the saw guide 1632. A pair of threaded fasteners 1816 is provided to fix a attached saw guide 1632 to the pivot plate 1716 by tightening knobs 1812 attached to the threaded fasteners 1816, thereby drawing the T-bar 1804 towards the pivot plate 1716, and clamping flanges 1652 of the saw guide 1632 between the T-bar 1804 and the pivot plate 1716 (see FIG. 18C). Holes 1824 in the pivot plate 1716 through which the threaded fasteners 1816 extend can be oversized relative to the threaded fasteners 1816, to allow for adjustments to the alignment of the attached T-bar 1804 or other attached accessory to be made. In addition, a locating screw 1816 can be provided that extends through a hole 1820 formed in the pivot plate 1716 and that is received by a threaded hole 1828 in the T-bar 1804. Multiple sets of the holes 1820 and 1824 can be provided to accommodate different accessories or to allow an accessory to be mounted at different locations on the pivot plate 1716.

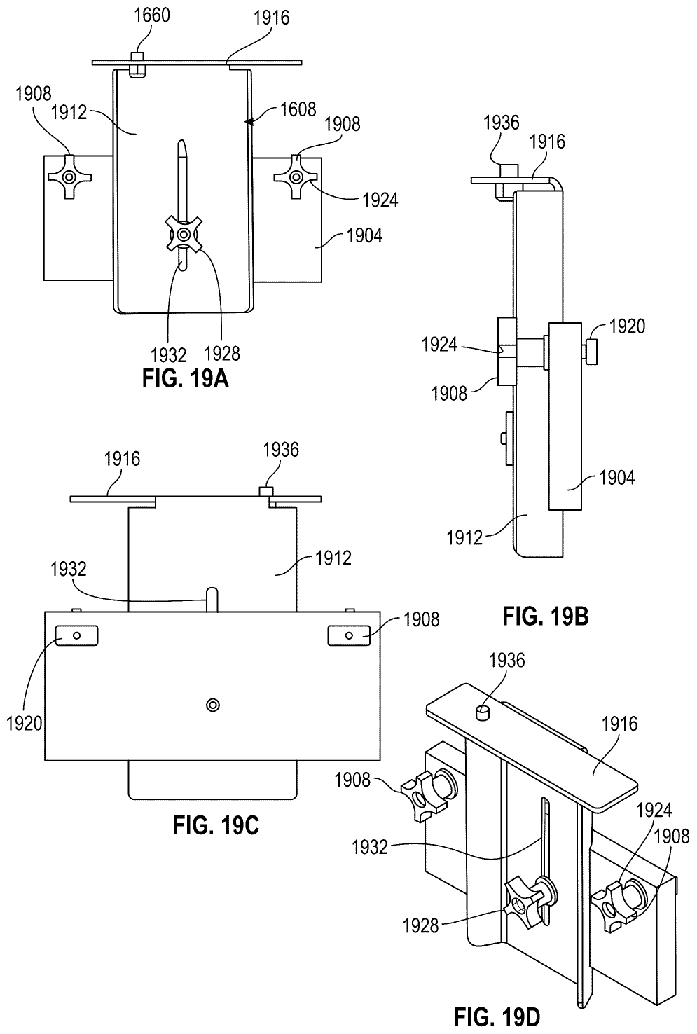

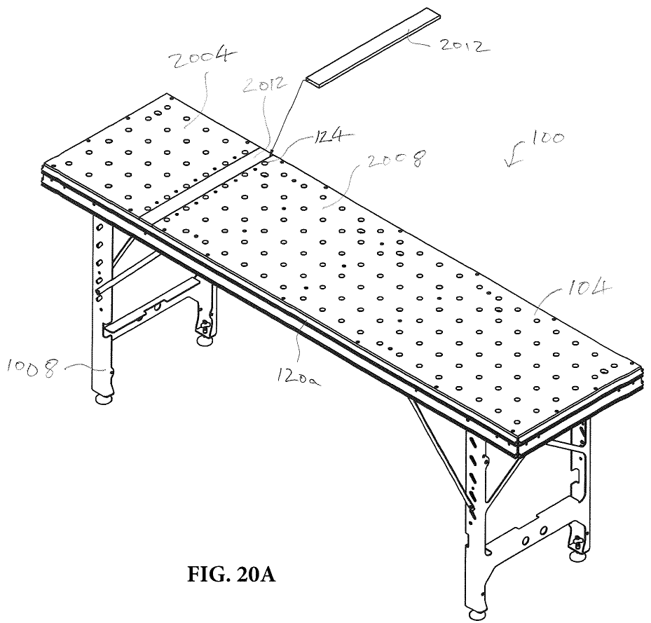

In FIGS. 19A-D, the saw guide support 1608 is shown in rear elevation, right side elevation, front elevation, and top perspective views respectively. The saw guide support 1608 generally includes a base plate 1904, which includes mounts 1908 for attaching the saw guide support 1608 to the track 120, a riser 1912, and a support surface 1916. The mounts 1908 can include a threaded plate 1920 and a threaded fastener 1924. The threaded plate 1920 is received by the horizontal clamp track 120. The location of the saw guide support 1608 along the track 120 can be fixed by tightening the mounts 1908, or adjusted by loosening the mount 1908 and moving the saw guide support 1608 to the desired position along the track 120. The height of the support surface 1916 can be adjusted by loosening a threaded fastener 1928 that extends through a vertical adjustment slot 1932 in the riser 1912, moving the riser 1912 until the support surface 1916 is at a desired height, and tightening the threaded fastener 1928. One or more locating pins 1936 extend from a surface of the support surface 1916, and are dimensioned to be received by the groove 1648 in the saw guide 1632 when the pivot plate assembly 1604 and the attached saw guide 1632 are placed in the down or cutting position.

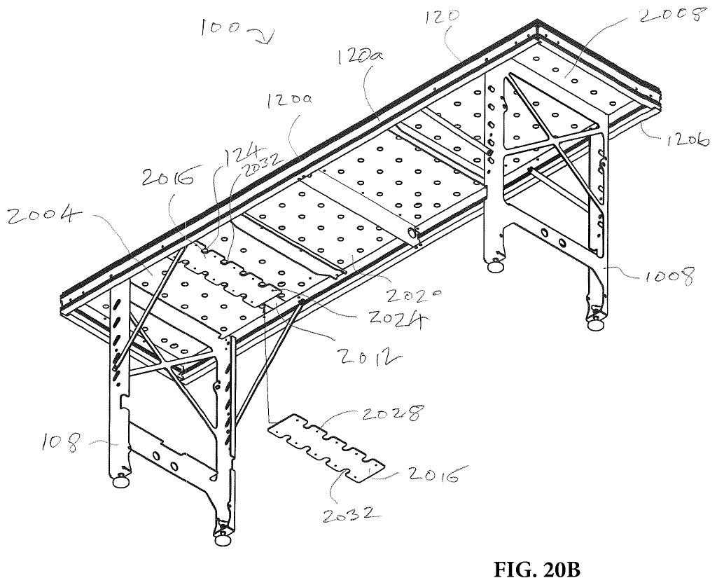

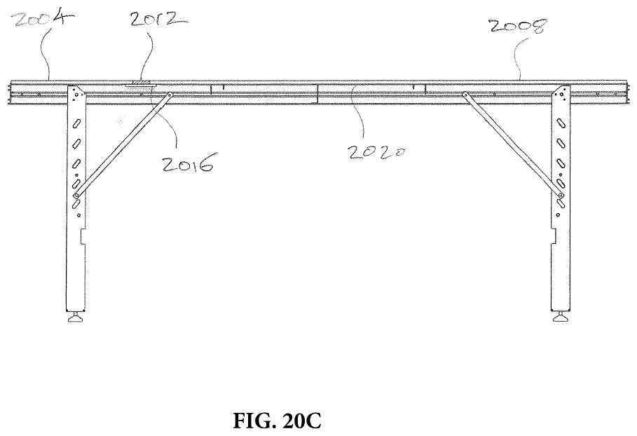

FIGS. 20A-C are front top perspective, front bottom perspective, and cross-section in elevation views respectively of a workbench or support surface assembly 100 in accordance with further embodiments of the present disclosure. The support surface assembly 100 generally includes a work surface 104 that is divided into a first worksurface component 2004 and a second worksurface component 2008. A cut strip 2012 is disposed between the first worksurface component 2004 and the second worksurface component 2008. The top surfaces of each of the first worksurface component 2004, the cut strip 2012, and the second worksurface component 2008 are disposed in a first plane. A joining plate 2016 is disposed on a bottom surface side of the worksurface 104. More particularly, a top or first surface of the joining plate 2016 is in contact with a portion of the bottom surface 2020 of the worksurface 104. In accordance with at least some embodiments of the present disclosure, a first portion of the first surface of the joining plate 2016 is in contact with a portion of the bottom surface of the first worksurface component 2004, a second portion of the first surface of the joining plate 2016 is in contact with at least a portion of the bottom surface of the cut strip 2012, and a third portion of the bottom surface of the joining plate 2016 is in contact with a portion of the bottom surface of the second worksurface component 2008.

In at least some embodiments of the present disclosure, a thickness of the first worksurface component 2004, a thickness of the second work surface component 2008, and a thickness of the cut strip 2012, are all the same. Accordingly, the top surfaces of the first worksurface component 2004, the second worksurface component 2008, and the cut strip 2012 can all be disposed in a first plane, while the bottom surfaces of the first worksurface component 2004, the second worksurface component 2008, and the cut strip 2012 can all be disposed in a second plane. In accordance with the least some embodiments of the present disclosure, the cut strip 2012 is received within a volume defined by an edge of the first worksurface component 2004, an edge of the second worksurface component 2008, a portion of a top surface of the joining plate 2016, a portion of an edge of a first or front horizontal rail 120a, and a portion of an edge of a second or rear horizontal rail 120b. In accordance with embodiments of the present disclosure, the cut strip 2012 can be held in position by gravity and/or friction.

Replacement of a worn cut strip 2012 can be performed by lifting the cut strip 2012 to be replaced from between the first 2004 and second 2008 work surface components, away from the joining plate 2016, and then dropping a replacement cut strip 2012 into the space vacated by the worn cut strip 2012.

The joining plate 2016 can be fixed to the first and second worksurface components by fasteners 2024 that extend through fixture apertures 2028 formed in the joining plate 2016. For instance, threaded fasteners 2024 can be received in the fixture apertures 2028 and can be screwed into the material of the first 2004 and second 2008 worksurface components. The joining plate 2016 therefore helps to maintain a fixed relationship between the first 2004 and second 2008 worksurface components. In addition, the joining plate 2016 can include a plurality of open slots 2032 along left and right side edges of the joining plate. As illustrated in FIG. 20B, the open slots can be sized and arranged so that the holes or apertures 124 formed in the work surface 104, adjacent the cut strip 2012, are not blocked by the joining plate 2016.

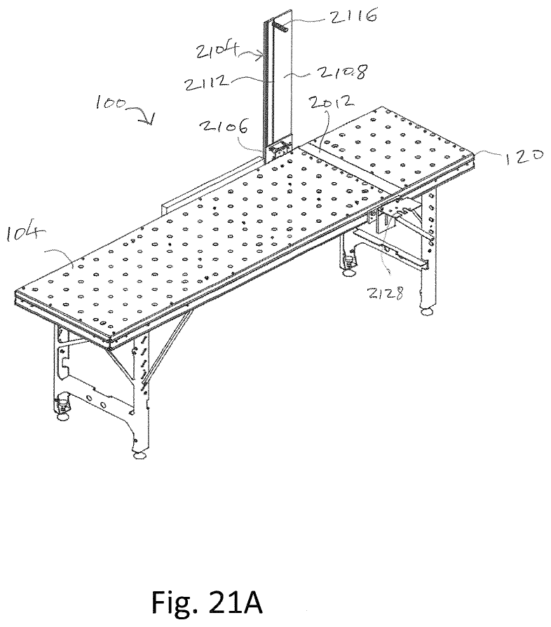

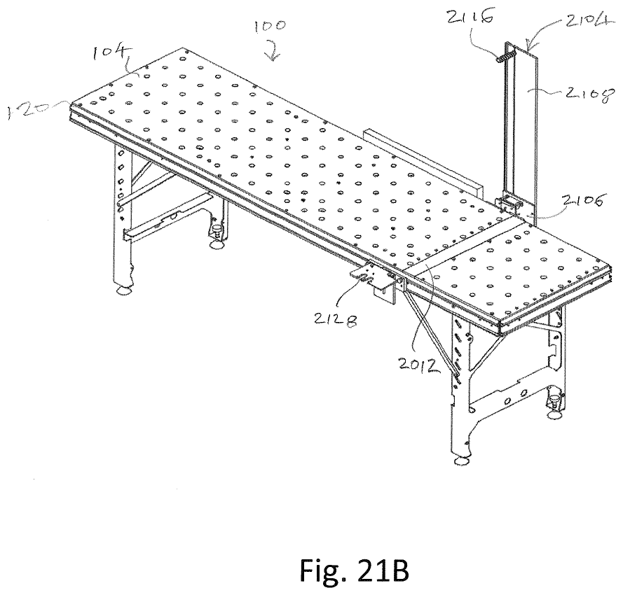

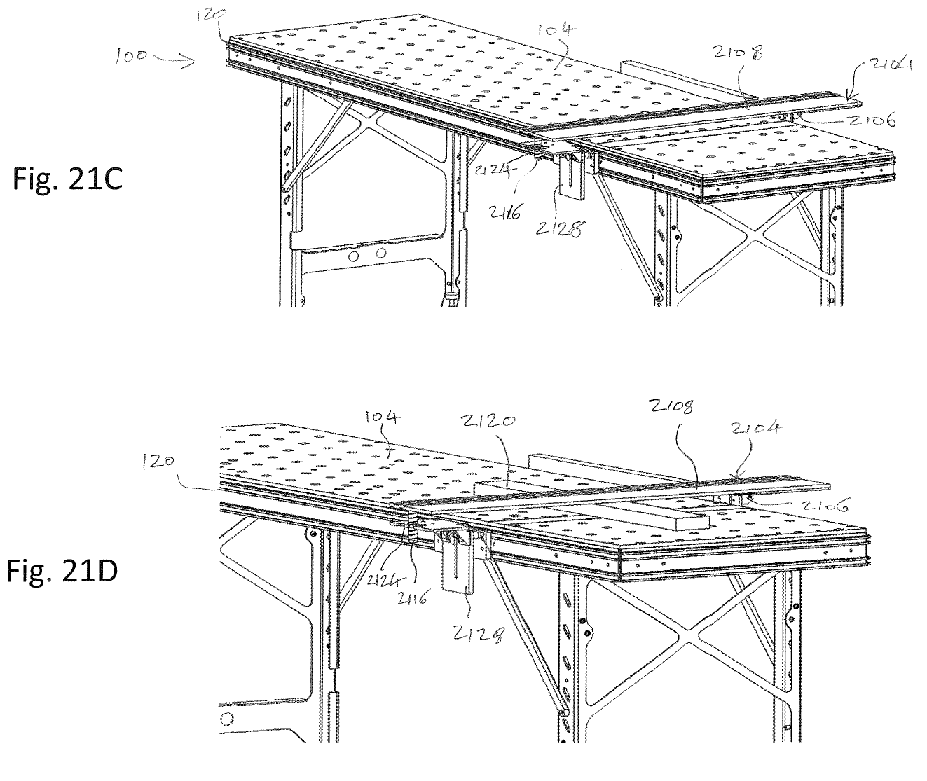

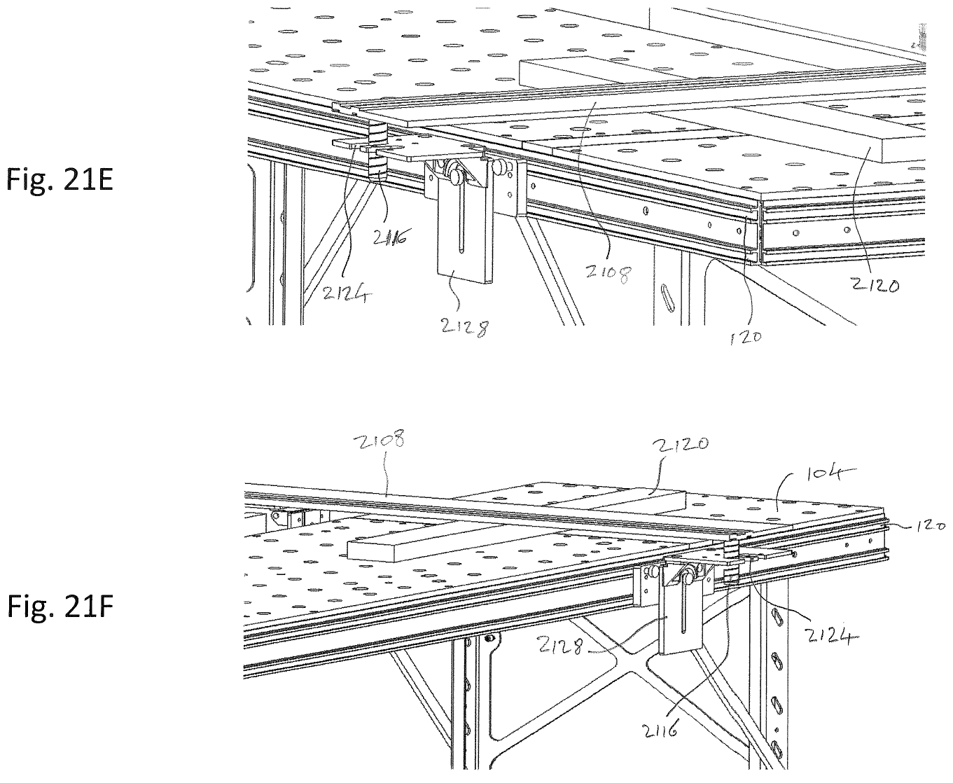

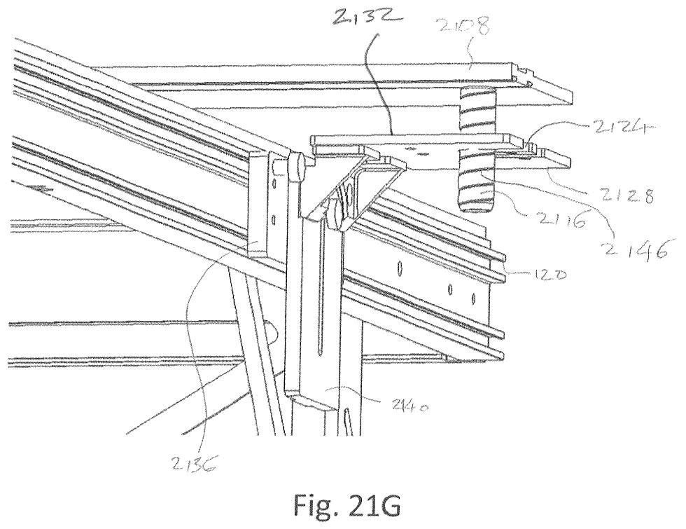

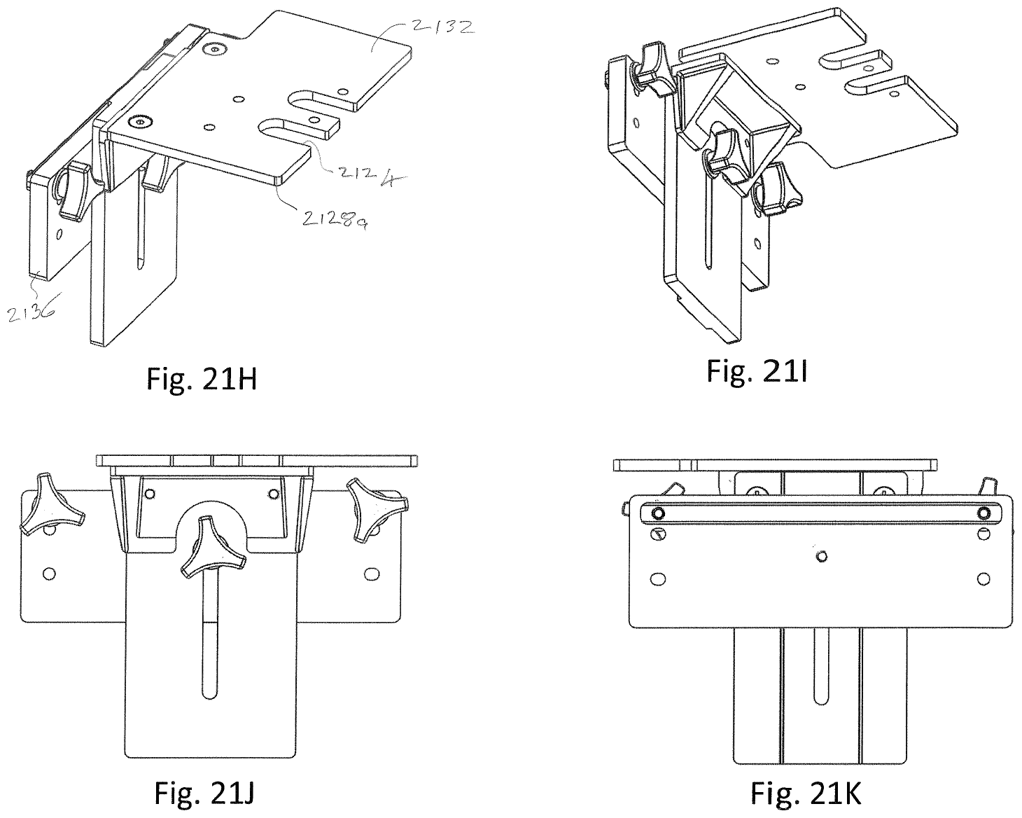

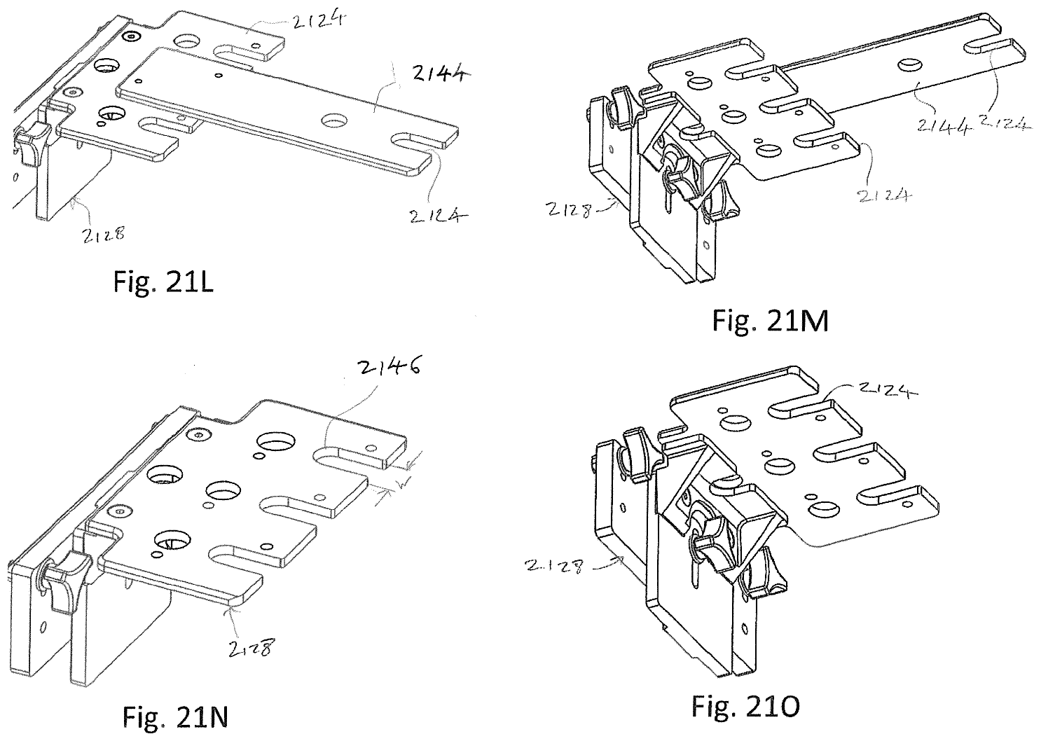

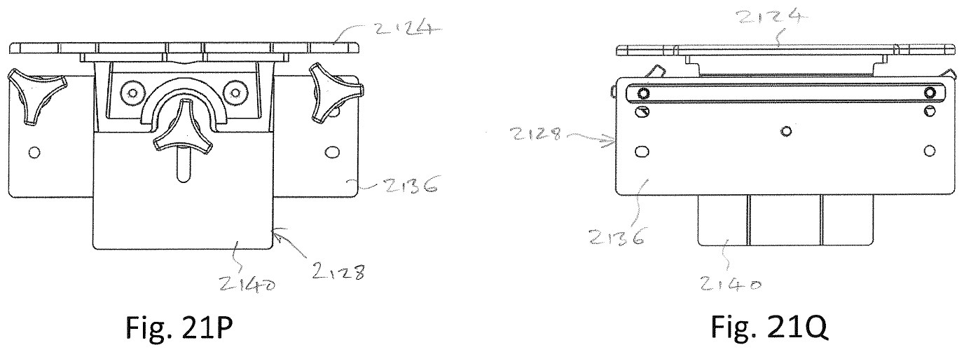

FIGS. 21A-Q are views of a workbench or support surface assembly 100 with an attached cross cut accessory in the form of a saw guide support assembly 2104 in accordance with other embodiments of the present disclosure. In accordance with embodiments of the present disclosure, the saw guide support assembly 2104 includes a saw guide or guide member 2108 that can be connected to a rear edge of the workbench 100, and in particular to a rear horizontal clamp track 120b, by a saw guide pivot plate assembly 2106. Accordingly, and as depicted in FIGS. 21A and 21B, the guide member 2108 of the saw guide support assembly 2104 can be lifted away from the work surface 104 when not in use or to facilitate the placement of a workpiece in a desired position on the work surface 104. The guide member 2108 can include features on a top surface to mate with a saw or other tool, either directly or through an adapter plate. As shown in the illustrated embodiment, the guide member 2108 includes a slot 2112 having a pair of flanges that is disposed on a side of the guide member 2108 that faces the worksurface 104. The slot 2112 receives a guide rod or locating rod 2116. When the guide member 2108 is placed against the work surface 104 or a workpiece 2120, the guide rod 2116 is received in an open slot 2124 of a front bracket 2128 (e.g. as shown in FIGS. 21C to 21G). The front bracket 2128 can be connected to a front horizontal clamp track 120a. As can be appreciated by one of skill in the art after consideration of the present disclosure, the guide rod 2116 and the open slot 2124 enable a location of the guide member 2108 along the front edge of the workbench 100 to be set and maintained, even where the guide member 2108 is spaced apart from a support surface or top plate 2132 of the front bracket 2128 due to the placement of a workpiece 2120 between the work surface 104 and the guide member 2108. Moreover, this arrangement allows workpieces 2120 of different thicknesses to be accommodated without needing to reset or adjust the front bracket 2128. Instead, a height adjustment need only be made at the saw guide pivot plate assembly 2106.

With reference now to FIGS. 21H to 21Q, particular aspects of embodiments of a front bracket 2128 are depicted. The front bracket 2128a shown in FIGS. 21H to 21K differs from the front bracket 2128b shown in FIGS. 21L to 21Q in the number of open-ended receiving slots 2124 disposed in a top plate 2132 of the front bracket 2128. In particular, the example front bracket 2128a includes two receiving slots 2124, while the example front bracket 2128b includes three receiving slots 2124. Each of the front brackets 2128 can include a base plate 2136 that is received by and that can be placed at a selected location along a horizontal rail 120 extending along an edge of the workbench 100 and adjustable riser 2140 can interconnect the base plate 2136 to the top plate 2132.

The receiving slots 2124 can feature a width W that is matched to the diameter of the guide rod 2116. In addition, the receiving slots 2124 can feature a closed rear portion 2144 with a radius R that is matched to the diameter of the guide rod 2116. In accordance with embodiments of the present disclosure, the dimensions of a receiving slot 2124 are matched to the diameter of a guide rod 2116 if those dimensions provide clearance to allow the guide rod 2116 to be received by the receiving slot 2124, and if those dimensions allow zero or very little play between the guide rod 2116 and the receiving slot 2124 while the guide rod 2116 is received by the receiving slot 2124.

In accordance with further embodiments of the present disclosure, an extension plate 2144 can be interconnected to the top plate 2132 of a front bracket 2128. The extension plate 2144 can be provided with a receiving slot 2124. As can be appreciated by one of skill in the art after consideration of the present disclosure, the inclusion of an extension plate 2144 can allow a guide rod 2116 attached to a guide member 2108 of suitable length to be received by the receiving slot 2124 even when a relatively large work piece 2120 is placed on the work surface 104.

In accordance with embodiments of the present disclosure, the guide rod 2116 can include a threaded aperture disposed in an end of the guide rod 2116 that is proximate to the guide member 2108. The threaded aperture can receive a threaded fastener. In accordance with embodiments of the present disclosure, one end of the threaded fastener is received in the threaded aperture of the guide rod 2116, a middle portion of the threaded fastener extends between the flanges of the slot 2112, and a head of the threaded fastener is received by the slot 2112. The head of the threaded fastener can be sized relative to the slot 2112 so that rotation of the threaded fastener within the slot 2112 is prevented. This in turn allows a user to change a location of the guide rod 2116 along the slot 2112 by grasping the guide rod 2116, turning it so that it is moved relative to the threaded fastener and away from the guide member 2108, and then sliding the guide rod 2116 to the desired location along the slot 2112. In accordance with at least some embodiments of the present disclosure, the guide rod 2116 includes a spiral groove 2146 formed on an exterior of the guide rod 2116. The spiral groove 2146 can improve a user's grip on the guide rod 2116 while it is being repositioned along the guide member 2108, without compromising a fit between the guide rod 2116 and a receiving slot 2124. Once the guide rod 2116 is at the desired location, the user can secure the guide rod 2116 at that location by turning the guide rod 2116 so that it is moved relative to the threaded fastener and toward the guide member 2108 until the flanges of the slot 2112 are held between the fastener member and the guide rod 2116.

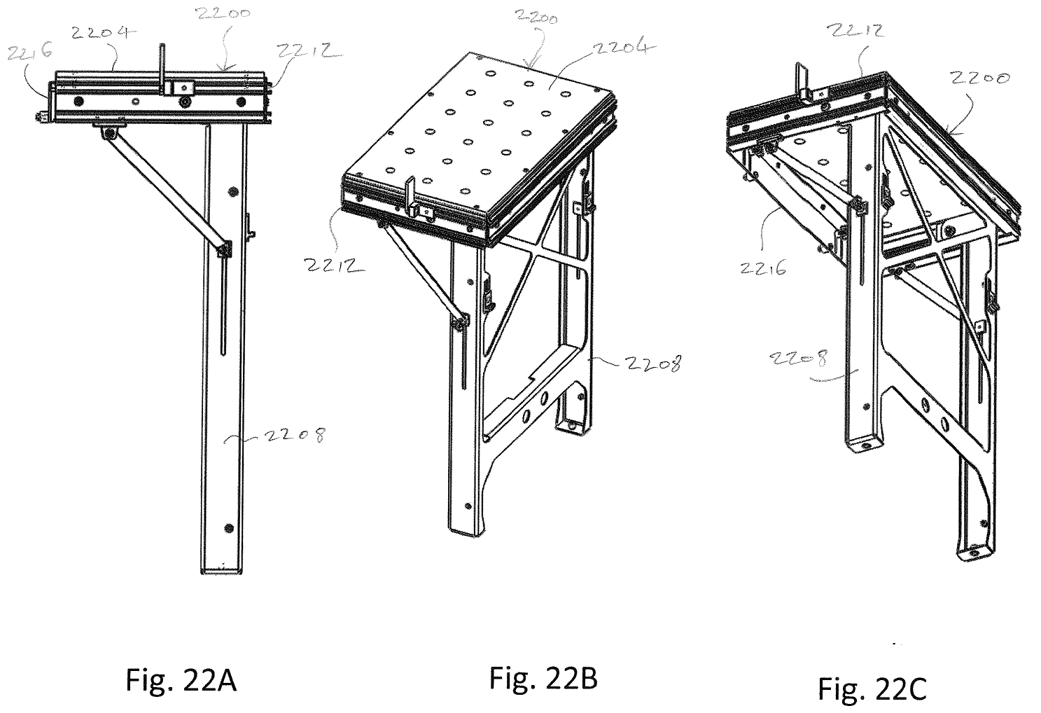

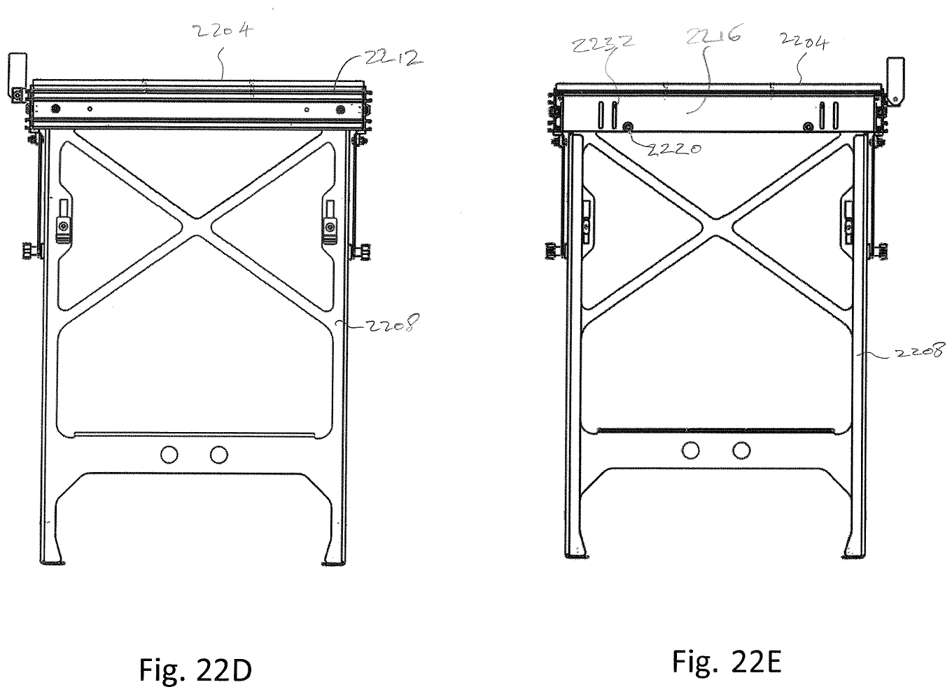

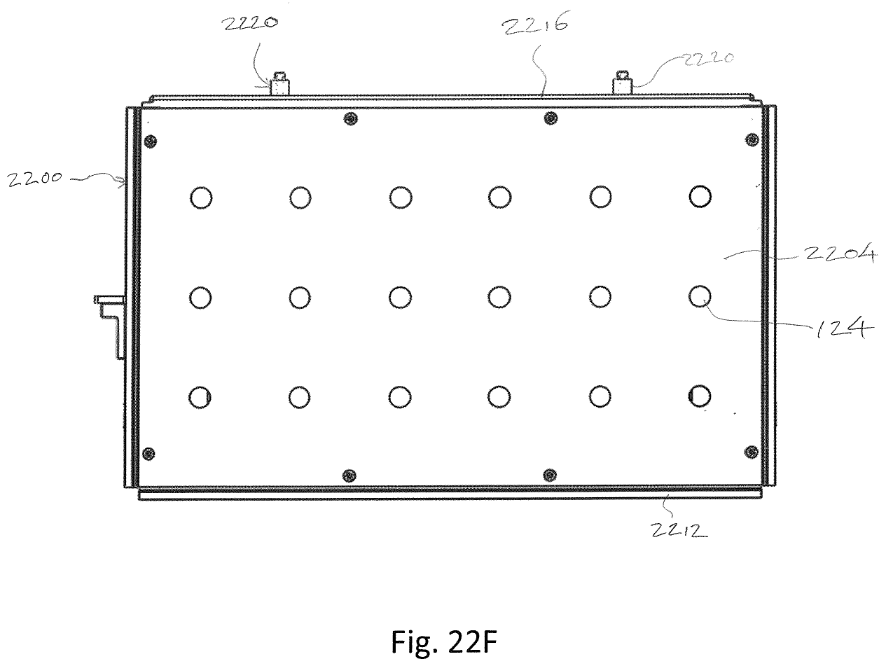

FIGS. 22A-F are views of a workbench extension assembly 2200 in accordance with embodiments of the present disclosure. The extension assembly 2200 generally includes an extension work surface 2204 and a pair of legs 2208. The extension work surface 2204 can include holes 124 that match the holes 124 formed in the work surface 104 of the workbench 100. Horizontal rails 2212 extend along three sides of the extension work surface 2204. The horizontal rails 2212 can match the horizontal rails 120 of the workbench 100. In accordance with at least some embodiments of the present disclosure, the horizontal rails 2212 are identical to the horizontal rails 120 of a workbench 100. For instance, each horizontal rail 120 and 2212 can include upper and lower tracks. Vertical rails can also be provided along the legs 2208 that are in a same plane as the horizontal rails 120. Accordingly, tools, guides, accessories and the like that can be used with the workbench can also be used with the workbench extension assembly 2200. A mounting plate 2216 extends along a fourth side of the extension work surface 2204. In accordance with embodiments of the present disclosure, the legs 2208 can be folded parallel to the work surface 2204 to facilitate moving and storage of the extension assembly 2200 when it is not in use.

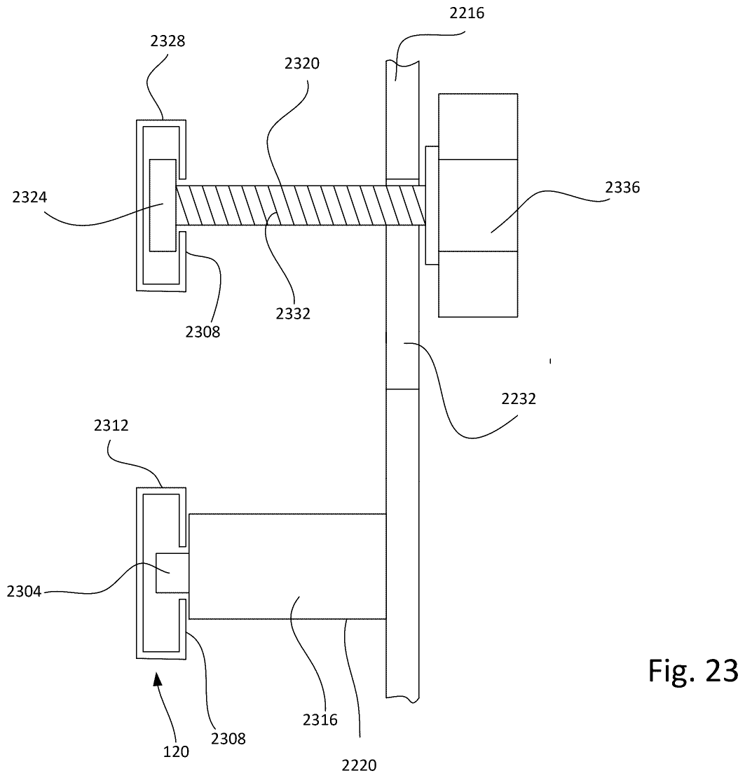

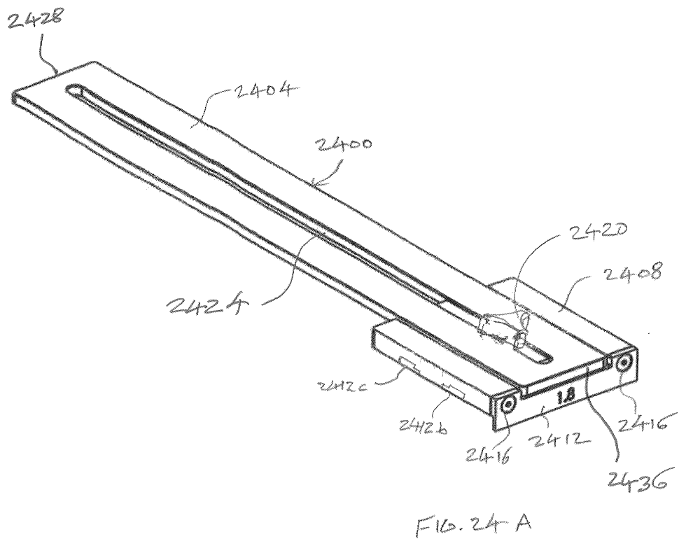

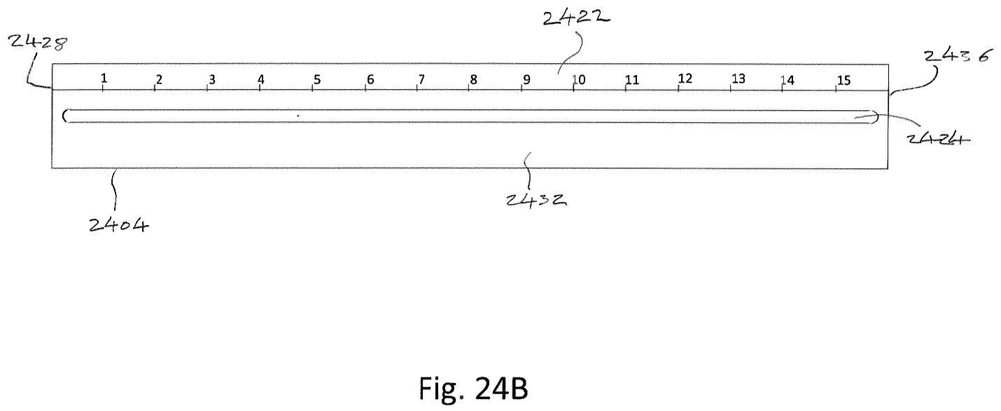

The mounting plate 2216 can include pins 2220 for locating the extension assembly 2200 relative to the workbench 100. For example, the mounting plate 2216 can include two mounting pins 2220. The mounting pins 2220 can be held at fixed locations on the mounting plate 2216, or can be placed in vertical slots that allow a height of the pins 2220 to be varied. As shown in FIG. 23, the mounting pins 2220 can include a head portion 2304 that is received between the flanges 2308 of a lower track 2312 of a workbench 100 rail 120, and a base portion 2316 having a diameter that is larger than a diameter of the head portion 2304, and that rests against an outer surface of the flanges 2308 of the lower track 2312 of the workbench 100 rail 120.

The mounting plate 2216 can also include vertical extending mounting slots 2232. As an example, the mounting plate 2216 can include two mounting slots 2232. Each mounting slot 2232 can be configured to receive a fixing bolt 2320 (see FIG. 23). Each fixing bolt 2320 can include a head portion 2324 that can be received between the flanges 2308 of an upper track 2328 of the workbench 100 rail 120, and a threaded body portion 2332 that can be passed through a slot 2232 and that is received in a threaded aperture of a knob 2336. The head portion 2324 can feature an extended length in an along track direction when placed within the track 2328, to prevent rotation of the fixing bolt 2320 when the knob 2336 is turned. With the head portions 2304 of the pins 2220 received between the flanges of the lower track 2312 of the rail 120, and with the head portions 2324 of the fixing bolts 2320 received in the upper track 2328 of the rail 120, a user can turn the knob 2336 associated with each of the fixing bolts 2320 to pull the head portions 2324 of the fixing bolts 2320 toward the knobs 2336, until the flanges 2308 of the upper track 2328 of the rail 120 are held securely between the head portions 2324 of the fixing bolts 2320 and a surface of the mounting plate 2216. This in turn secures the extension assembly 2200 to the workbench 100. By providing vertically aligned slots 2232, a height of the fixing bolts 2320 can be varied. Different heights and configurations of the mounting pins 2220 and fixing bolt 2320 can be used as needed, for instance to enable the workbench extension assembly 2200 to connect to workbenches having configurations different than a workbench 100 as disclosed herein.

The workbench extension assembly 2200 can be attached to a side of a workbench 100, to provided extended support for work pieces in a depth or front to back dimension. For instance, full size sheets of plywood or other materials can be supported by connecting a workbench extension assembly 2200 to a front side of a workbench 100. The workbench extension assembly 2200 can also be attached to an end of a workbench 100, effectively extending the work surface 104 in a side to side dimension, allowing relatively long work pieces to be better supported. In accordance with further embodiments of the present disclosure, multiple workbench extension assemblies 2200 can be secured to a single workbench 100. In accordance with still further embodiments of the present disclosure, one or more additional workbench extension assemblies 2200 can be connected in series to a workbench extension assembly 2200 that is attached to a workbench 100.

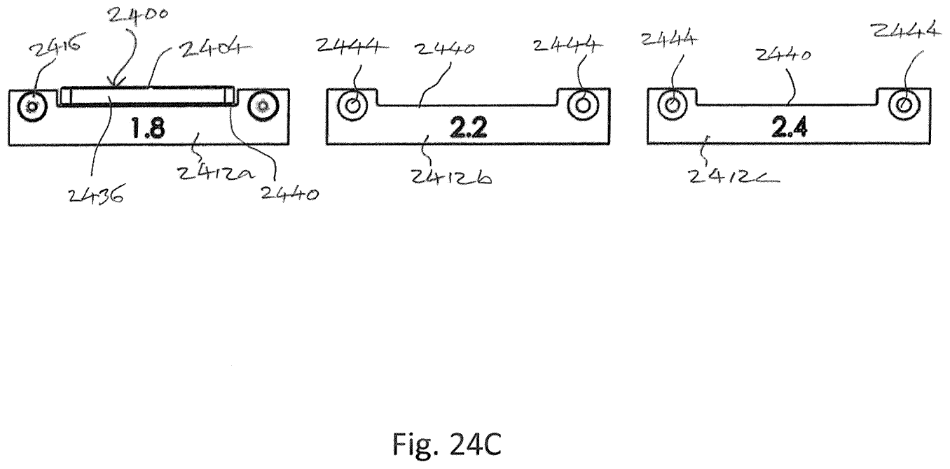

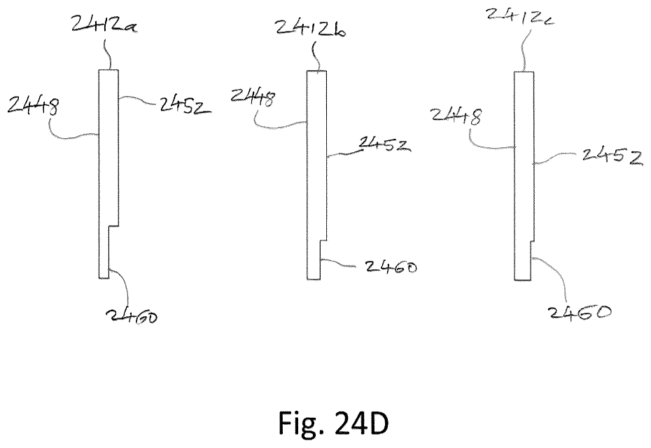

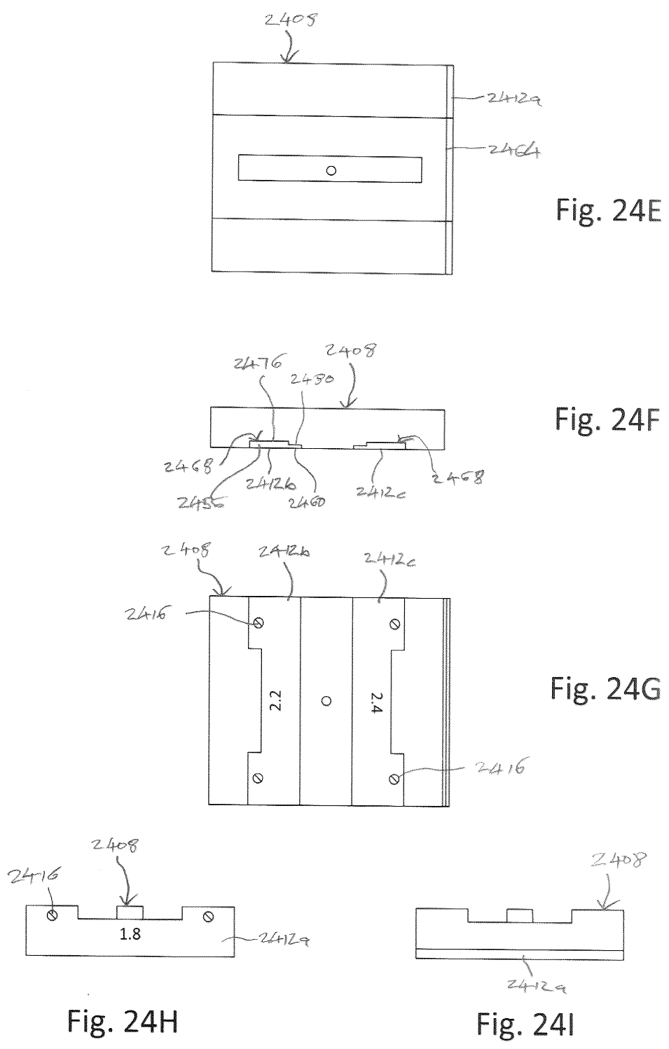

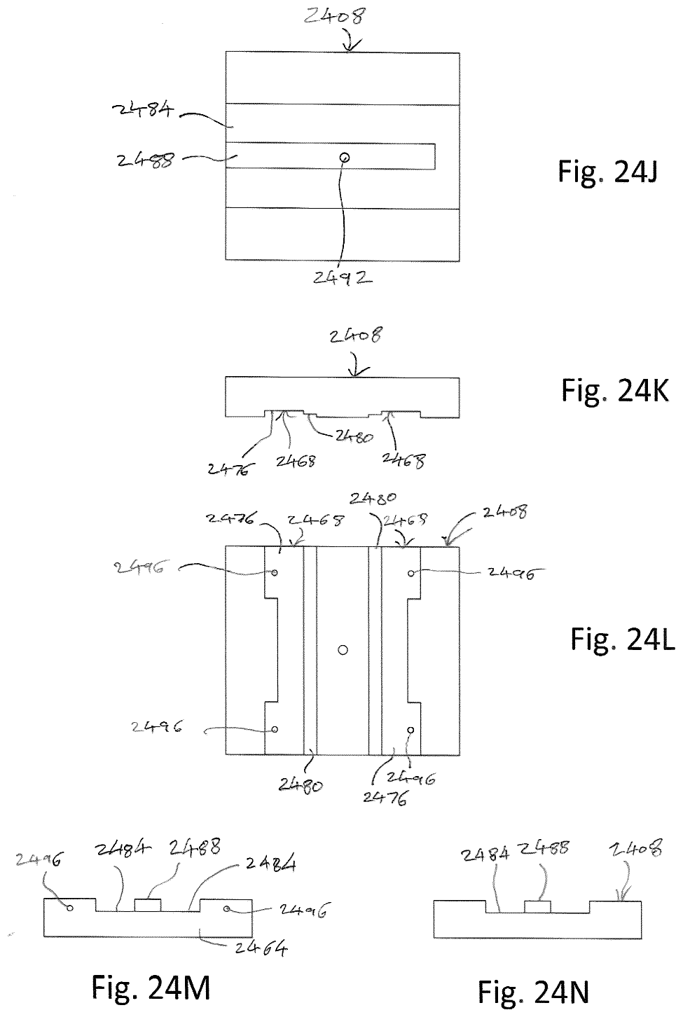

Embodiments of the present disclosure also encompass various alignment and/or measurement tools. For instance, and with reference now to FIGS. 24A-N, a rip gauge 2400 in accordance with embodiments of the present disclosure is shown in a perspective view. The rip gauge 2400 generally includes a gauge body 2404, a gauge block 2408, and a blade gauge 2412. The blade gauge 2412 is removably attached to the outer face of the end block 2408 by threaded fasteners 2416. As shown in FIG. 24A, the gauge block 2408 can be fixed to the gauge body 2404 by a fastener 2420 that passes through a slot 2424 formed in the gauge body 2404. As can be appreciated by one of skill in the art after consideration of the present disclosure, a distance of the gauge block 2408, and thus of the blade gauge 2412, from an end 2428 or 2436 of the gauge body 2404 can be selected by loosening the fastener 2420, moving the gauge block 2408 along the slot 2424 until the blade gauge 2412 is at a desired location along the gauge body 2404, and tightening the fastener 2420.

In accordance with at least some embodiments of the present disclosure, a scale 2422 can be included on a surface of the slotted body 2404. For example, and as shown in FIG. 24B, a scale 2422 that extends between opposing ends 2428 and 2436 can be disposed on a bottom surface 2432 of the slotted body 2404. The inclusion of a scale 2422 enables a user to place a blade gauge 2412 at a desired distance from an end 2428 or 2436, without requiring the use of a separate measurement tool. Moreover, by selecting a blade gauge 2412 having a thickness matching a kerf of a saw blade that will be used to make a cut, placement of a workpiece relative to the saw blade such that it is accurately cut to a desired size can be facilitated.

In accordance with embodiments of the present disclosure, and as depicted in FIG. 24C, blade gauges 2412 are available in different thicknesses to match different saw blade kerfs. As examples, but without limitation, blade gauges 2412 can be provided in thicknesses of 1.8 mm (shown attached to the end block 2408a in FIG. 24A or C), 2.2 mm (blade gauge 2412b), and 2.4 mm (blade gauge 2412c). Each blade gauge 2412 can include a recess 2440 to provide clearance for the gauge body 2404 when the blade gauge 2412 is connected to the gauge body 2404 by a gauge block 2408. In addition, each blade gauge 2412 can include one or more holes 2444 that can each be configured to receive a fastener 2416 for connecting the blade gauge 2412 to the gauge block 2408.

FIG. 24D depicts example blade gauges 2412 in side elevation views. As shown, each blade gauge generally includes a reference surface 2448, a mounting surface 2452, a mounting portion 2456, and a gauge portion 2460. When installed on a gauge block 2408, some or all of the mounting surface 2452 is in contact with an end of the gauge block 2408. Moreover, when the blade gauge 2412 is interconnected to a gauge body 2404 by a gauge block 2408, a distance that the gauge blade 2404 that the blade gauge 2412 is located can be determined by reading the location of the reference surface 2448 along the scale 2420.

FIGS. 24E-I are top plan, side, bottom plan, first end, and second end views respectively of an example of a gauge block 2408 and attached blade gauges 2412 in accordance with embodiments of the present disclosure. More particularly, in this example, a selected blade gauge 2412a is attached to a mounting surface 2464 of the gauge block 2408. With the blade gauge 2412a installed, and with the gauge block 2408 connected to the gauge body 2404 at a desired distance from an end 2428 or 2436 of the gauge body 2404, the placement of a workpiece relative to a saw blade can be facilitated. Moreover, by selecting a blade gauge 2412 with a gauge portion 2460 thickness corresponding to the kerf of the saw blade, accuracy of the placement of the workpiece can be assured. Also in this example, blade gauges 2412b and 2412c that are not in use (or that are not attached to the mounting surface 2464 of the gauge block 2408) are held in storage slots 2468 formed in a bottom surface 2472 of the gauge block 2408. Each storage slot 2468 can include a first recess 2476, in which the mounting portion 2456 of a blade gauge 2412 can be received, and a second recess 2480 that provides clearance for the gauge portion 2460 of the blade gauge 2412. As shown in the figures, blade gauges 2412 can be held in respective storage slots 2468 by fasteners 2416.

FIGS. 24J-N are top plan, side, bottom plan, first end, and second end views respectively of an example of a gauge block 2408. More particularly, the gauge block 2408 is depicted alone, without any attached blade gauges 2412. With reference to the top (FIG. 24J) and end (FIGS. 24M and 24N) views, the gauge block 2408 in this example can be seen to include a center channel 2484, in which a gauge body 2404 can be received, and a locating ridge 2488, which can extend into the slot 2424 of a gauge body 2404. A threaded hole 2492 can be provided in the locating ridge 2488 for receiving a fastener 2420 when the gauge body 2404 is connected to a gauge block 2408. In addition, threaded holes 2496 can be provided in the mounting surface 2464 for receiving fasteners 2416 used to connect a blade gauge 2412 to the gauge block 2408. With reference to FIGS. 24K and 24L, the storage slots 2468 provided to store blade gauges 2412 that are not joined to the mounting surface 2464 can be seen. Threaded holes 2496 can be provided in the first recess 2476 of each storage slot 2468 to receive fasteners 2416 used to hold a blade gauge 2412 in the storage slot 2468.

Accordingly, by setting the end block 2408 at a location along the body 2404 corresponding to a desired cut location, and by selecting a blade gauge 2412 with a width that corresponds to the kerf of the saw blade that will be used to make the cut, an accurate cut can be ensured.

Other alignment tools include squares and set up blocks that can be placed on the surface 104 of the workbench 100 or the surface 2204 of the workbench extension assembly 2200. In accordance with at least some embodiments of the present disclosure, an alignment tool can be configured for placement in holes 124 formed in the surface 104 or 2204.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A work surface assembly, comprising:
a work surface;
a plurality of legs;
a first horizontal clamp track, wherein the first horizontal clamp track extends along a first edge of the work surface;
a second horizontal clamp track, wherein the second horizontal clamp track extends along a second edge of the work surface;
a pivot plate assembly, wherein the pivot plate assembly is connected to the first horizontal clamp track, and wherein the pivot plate assembly includes:
a base plate; and
a pivot plate interconnected to the base plate;
a mounting bracket assembly, wherein the mounting bracket assembly is connected to the second horizontal clamp track, and wherein the mounting bracket assembly includes:
a base plate; and
a top plate interconnected to the base plate, wherein the top plate includes a receiving slot; and
a guide member, wherein the guide member is connected to the pivot plate assembly adjacent a first end of the guide member, wherein the guide member includes a locating rod adjacent a second end of the guide member, and wherein, with the guide member pivoted so as to extend substantially parallel to a top of the work surface, the locating rod is received by the receiving slot of the mounting bracket assembly.

2. The work surface assembly of claim 1, wherein the receiving slot has an open end along an edge of the top plate, and wherein the open end faces away from the pivot plate assembly.

3. The work surface assembly of claim 2, wherein the pivot plate assembly additionally includes a riser that interconnects the base plate and the pivot plate, and
wherein the bracket assembly additionally includes a riser that interconnects the base plate and the top plate.

4. The work surface of claim 3, wherein the riser is adjustable.

5. The work surface assembly of claim 1, wherein in a first, extended configuration, a longitudinal axis of each of the legs in the plurality of legs is substantially orthogonal to a plane of the top of the work surface.

6. The work surface assembly of claim 1, the pivot plate assembly further comprising:
an attachment assembly, wherein the attachment assembly interconnects the guide member to the pivot plate assembly, wherein the attachment assembly includes a T-bar, wherein the T-bar is connected to the pivot plate by a plurality of locating pins, wherein the plurality of locating pins include two locating pins that are fixed to and that extend from the T-bar, wherein the locating pins are received by holes in the pivot plate, and wherein the T-bar is additionally connected to the pivot plate by a threaded fastener.

7. A work surface assembly, comprising:
a work surface, including:
a first work surface component;
a second work surface component; and
a cut strip, wherein the cut strip is interposed between the first work surface component and the second work surface component, and wherein a top surface of the first work surface component, a top surface of the second work surface component, and a top surface of the cut strip lie in a first plane; and
a joining plate, wherein a first surface of the joining plate is in contact with a portion of a bottom surface of the first work surface component, a portion of a bottom surface of the cut strip, and a portion of a bottom surface of the second work surface component.

8. The work surface assembly of claim 7, further comprising:
a first horizontal rail, wherein the first horizontal rail extends adjacent a back edge of the bottom surface of the first work surface component, adjacent a back edge of the bottom surface of the cut strip, and adjacent a back edge of the bottom surface of the second work surface component.

9. The work surface assembly of claim 8, wherein the first work surface component, the cut strip, and the second work surface component have a same thickness.

10. The work surface assembly of claim 9, wherein the wherein the bottom surface of the first work surface component, the bottom surface of the cut strip, and the bottom surface of the second work surface component lie in a second plane.

11. The work surface assembly of claim 8, wherein the cut strip is received within a volume defined by an edge of the first work surface component, a portion of a top surface of the joining plate, an edge of the second work surface component, a portion of an edge of the first horizontal rail, and a portion of an edge of the second horizontal rail.

12. The work surface assembly of claim 11, wherein the cut strip is not fixed to any of the first work surface component, the joining plate, the second work surface component, the first horizontal rail, or the second horizontal rail.

13. The work surface assembly of claim 7, wherein the first work surface component includes a first plurality of apertures that extend between the top and bottom surfaces of the first work surface component, wherein the second work surface component includes a second plurality of apertures that extend between the top and bottom surfaces of the second work surface component, wherein a subset of the first plurality of apertures are coincident with a first set of slots included in the joining plate, and wherein a subset of the second plurality of apertures are coincident with a second set of slots included in the joining plate.

14. The work surface assembly of claim 13, wherein the joining plate includes a plurality of fixture apertures, wherein the joining plate is connected to the first work surface component by a first set of fixtures that extend through a first subset of the fixture apertures, and wherein the joining plate is connected to the second work surface component by a second set of fixtures that extend through a second subset of the fixture apertures.

15. A method for locating a guide member, comprising:
providing a portable workbench, the portable workbench including:
a planar top surface;
a plurality of legs;
connecting a pivot plate assembly to a first horizontal clamp track that extends along a first edge of the top surface;
connecting a front bracket to a second horizontal clamp track that extends along a second edge of the top surface;
connecting a guide member to the pivot plate assembly; and
positioning a guide rod along the guide member so that it can be received by a receiving slot in a top plate saw of the front bracket.

16. The method of claim 15, further comprising:
pivoting the guide member away from the top surface of the portable workbench;
placing a workpiece on the top surface of the portable workbench; and
pivoting the guide member toward the top surface of the portable workbench, wherein the workpiece is between the top surface of the portable workbench and the guide member.

17. The method of claim 16, further comprising:
adjusting a height of the pivot plate assembly.
